(19) United States
(12) Patent Application Publication
(10) Pub. No.: US 2019/0165486 A1
(43) Pub. Date: May 30, 2019

(54) MOBILE COMMUNICATION TERMINAL

(71) Applicant: FUJIFILM Corporation, Tokyo (JP)

(72) Inventor: Masafumi YOSHIDA, Kanagawa (JP)

(73) Assignee: FUJIFILM Corporation, Tokyo (JP)

(21) Appl. No.: 16/263,468

(22) Filed: Jan. 31, 2019

Related U.S. Application Data
(63) Continuation of application No. PCT/JP2017/031039, filed on Aug. 30, 2017.

(30) Foreign Application Priority Data
Sep. 23, 2016 (JP) 2016-185904

(51) Int. Cl. H01Q 21/06; H01Q 1/24; H01Q 3/36; H01Q 1/38; H04M 1/02

(52) U.S. Cl. CPC H01Q 21/061; H01Q 1/243; H04M 1/0202; H01Q 1/38; H01Q 3/36

(57) ABSTRACT

A mobile communication terminal capable of maintaining communication with the outside is provided. The mobile communication terminal includes a proximity sensor, a film antenna, a casing antenna, and a control unit, and the proximity sensor, the film antenna, the casing antenna, and the control unit are provided in the casing. It is preferable for a main component of the casing to be a metal.

### CROSS-REFERENCE TO RELATED APPLICATIONS

This application is a Continuation of PCT International Application No. PCT/JP2017/031039 filed on Aug. 30, 2017, which claims priority under 35 U.S.C. § 119(a) to Japanese Patent Application No. 2016-185904 filed on Sep. 23, 2016. The above application is hereby expressly incorporated by reference, in its entirety, into the present application.

### BACKGROUND OF THE INVENTION

### 1. Field of the Invention

The present invention relates to a mobile communication terminal such as a smartphone or a tablet, and more particularly, to a mobile communication terminal including a metal mesh antenna, a proximity sensor, and an antenna provided in a casing.

### 2. Description of the Related Art

In mobile communication terminals having a touch panel mounted thereon, such as a smartphone or a tablet, function advancement, miniaturization, thickness reduction, and weight reduction of mobile terminal devices currently progress. A plurality of antennas such as a telephone antenna, an antenna for WiFi (Wireless Fidelity), and an antenna for Bluetooth (registered trademark) are mounted on the mobile communication terminals.

JP2015-162733A describes that the amount of radiation of radio waves to a human body is reduced in a mobile terminal device using a plurality of antennas at the same time.

The mobile terminal device in JP2015-162733A includes a plurality of antennas, a human sensor, and an antenna switching device that can switch each of the plurality of antennas between a use state and a non-use state and can switch between radiation patterns of each antenna in a use state. Further, the mobile terminal device in JP2015-162733A includes a communication control unit that selects an antenna that the mobile terminal device will use for communication on the basis of an output result of the human sensor. The antenna switching device selects the antenna to be used for communication according to a selection result of the antenna in a selection unit, switches the selected antenna to a use state, and switches between the radiation patterns of the selected antenna on the basis of the output of the human sensor.

### SUMMARY OF THE INVENTION

In the next generation communication standard 5G (Generation) to be served from 2020, 24.25 to 86 GHz is an examination target frequency. Radio waves at such high frequencies are greatly shielded by a human body as compared with radio waves of the communication standard 4G (Generation) of a frequency band of 450 MHz to 3.6 GHz, and have great influence on the human body with respect to radio wave shielding.

A mobile communication terminal has various uses, and there are also various using methods. The mobile communication terminal is held with one hand along a uniaxial direction, and comes in contact with an ear at the time of calling. In this case, only the ear comes in contact with the mobile communication terminal, but in a case where there is an antenna in a region in which the ear comes in contact, reception efficiency of the antenna is greatly degraded.

Meanwhile, the mobile communication terminal is set sideways and held with hands at both sides at the time of playing a game or viewing a moving image. In this case, the hand comes in contact with only two side portions of the mobile communication terminal, but in a case where there is an antenna at both the side portions, reception efficiency of the antenna is greatly degraded.

An antenna of the mobile communication terminal is disposed behind a decorative portion which is on an edge part of the mobile communication terminal called a frame portion. However, a proportion of occupancy of a display screen on the viewer side of the mobile communication terminal has increased, a development for reducing the frame portion progresses, and a placement place of the antenna is being narrowed. Further, it is necessary to provide a place with which a human body does not come in contact in order to stably perform communication, but such a place is going to disappear due to diversification of a method of using the mobile communication terminal as described above. Further, there is no antenna which is not shielded by a human body at the time of moving while looking at a screen of the mobile communication terminal. Therefore, reception efficiency is greatly degraded.

Further, in a mobile communication terminal, a luxurious feeling of a metal casing is preferred, and radio wave absorption of the metal casing also involves in restriction of antenna installation.

In JP2015-162733A, the antenna is provided in the frame portion of the mobile terminal device. However, at present, development is progressed to eliminate the frame portion, and there is a tendency that the antenna is not provided on a side surface. Further, the antennas in upper and lower portions of the mobile terminal device overlap fingers in a case where the mobile terminal device is held horizontally. The antennas are shielded by the human body.

Further, in JP2015-162733A, although a plurality of antennas are provided in the casing, beam forming is not considered at all. Therefore, reception efficiency is greatly degraded in the mobile terminal device of JP2015-162733A. As described above, in the mobile communication terminal, it is difficult for communication with the outside to be maintained due to various restrictions.

An object of the present invention is to provide a mobile communication terminal capable of solving the problems based on the related art described above and maintaining communication with the outside.

In order to achieve the above object, the present invention provides a mobile communication terminal including a casing, the mobile communication terminal including: a proximity sensor, a film antenna, a casing antenna, and a control unit, wherein the proximity sensor, the film antenna, the casing antenna, and the control unit are provided in the casing.

It is preferable for a main component of the casing to be a metal. It is preferable for the metal to be aluminum.

It is preferable for the film antenna to be an array antenna. Further, it is preferable for the mobile communication terminal to further include a phase shifter connected to the array antenna.

It is preferable for the film antenna to be a phased array antenna. It is preferable for the film antenna to have a dot pattern.

It is preferable for the proximity sensor to be an infrared sensor using infrared rays. Further, it is preferable for the proximity sensor to include a casing antenna.

It is preferable for the casing antenna has a maximum length of 2 cm or less.

It is preferable for the film antenna to be formed of a fine metal wire having a line width of 3 μm or less.

It is preferable for the film antenna to have a line width of 1.5 μm or less.

It is preferable for the film antenna to have a maximum length of 2 cm or less.

It is preferable for the casing to have a rectangular parallelepiped shape, and for the proximity sensor to be provided at one end portion in a longitudinal direction of the casing.

Further, it is preferable for the casing to have an opening, for a display unit to be provided in the opening, and for the film antenna to be provided on the display unit and in a region of the opening.

According to the present invention, communication with the outside can be maintained.

### BRIEF DESCRIPTION OF THE DRAWINGS

FIG. 1 is a schematic perspective view illustrating a mobile communication terminal according to an embodiment of the present invention.

FIG. 2 is a schematic cross-sectional view illustrating the mobile communication terminal according to the embodiment of the present invention.

FIG. 3 is a schematic diagram illustrating a configuration on the viewer side of the mobile communication terminal according to the embodiment of the present invention.

FIG. 4 is a schematic diagram illustrating a configuration of the back side of the mobile communication terminal according to the embodiment of the present invention.

FIG. 5 is a schematic cross-sectional view of the side surface side of the mobile communication terminal according to the embodiment of the present invention.

FIG. 6 is a schematic plan view illustrating a first example of a touch sensor unit of the mobile communication terminal according to the embodiment of the present invention.

FIG. 7 is a schematic cross-sectional view illustrating the first example of the touch sensor unit of the mobile communication terminal according to the embodiment of the present invention.

FIG. 8 is a schematic cross-sectional view illustrating a second example of the touch sensor unit of the mobile communication terminal according to the embodiment of the present invention.

FIG. 9 is a schematic cross-sectional view illustrating a third example of the touch sensor unit of the mobile communication terminal according to the embodiment of the present invention.

FIG. 10 is a schematic diagram illustrating a fourth example of the touch sensor unit of the mobile communication terminal according to the embodiment of the present invention.

FIG. 11 is a schematic cross-sectional view illustrating a configuration of a film antenna of the mobile communication terminal according to the embodiment of the present invention.

FIG. 12 is a schematic diagram illustrating a mobile communication terminal according to a second embodiment of the present invention.

FIG. 13 is a flowchart showing antenna switching.

FIG. 14 is a schematic diagram illustrating a first example of the antenna.

FIG. 15 is a schematic diagram illustrating a second example of the antenna.

FIG. 16 is a schematic cross-sectional view illustrating a first metal film forming step.

FIG. 17 is a schematic cross-sectional view illustrating a resist film forming step.

FIG. 18 is a schematic cross-sectional view illustrating a second metal film forming step.

FIG. 19 is a schematic cross-sectional view illustrating a resist film removing step.

FIG. 20 is a schematic cross-sectional view illustrating a conductive portion forming step.

### DESCRIPTION OF THE PREFERRED EMBODIMENTS

Hereinafter, a mobile communication terminal of the present invention will be described in detail on the basis of preferred embodiments illustrated in the attached drawings.

Hereinafter, “to” indicating a numerical range includes numerical values described on both sides. For example, in a case where ε is a numerical value α to a numerical value β, a range of ε is a range including the numerical value α and the numerical value β and is α≤ε≤β in a case where represented by a mathematical symbol.

An angle such as “an angle represented by a specific numerical value”, “parallel”, “vertical”, and “orthogonal” include an error range generally accepted in the relevant technical field, unless otherwise specified.

Further, “the same”, “all”, and the like include an error range generally accepted in the relevant technical field.

“Transparent” means light transmittance that is at least 60% or more, preferably 75% or more, more preferably 80% or more, and still more preferably 85% or more in a visible light wavelength range of wavelengths of 400 to 800 nm.

The light transmittance is measured using, for example, “Plastics—A Method of Obtaining Total Light Transmittance and Total Light Reflectance” defined by JIS (Japanese Industrial Standards) K 7375: 2008.

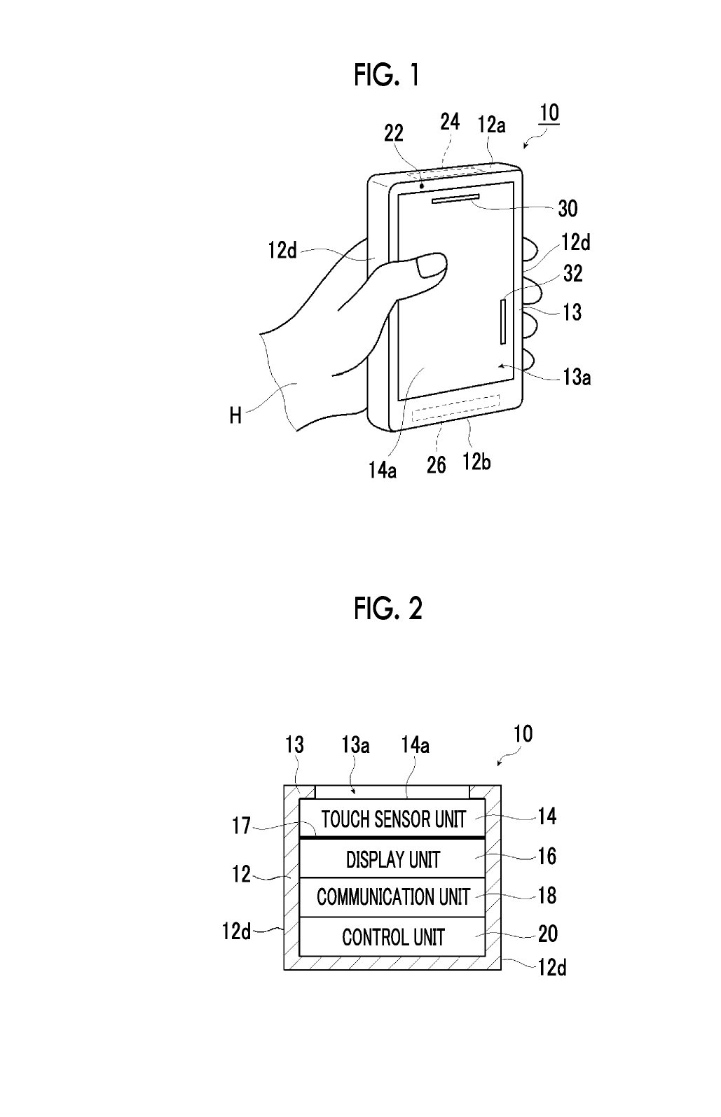

FIG. 1 is a schematic perspective view illustrating a mobile communication terminal according to an embodiment of the present invention, and FIG. 2 is a schematic cross-sectional view illustrating the mobile communication terminal according to the embodiment of the present invention.

The mobile communication terminal 10 illustrated in FIG. 1 includes a casing 12. The mobile communication terminal 10 includes a proximity sensor 22, a casing antenna, a film antenna, and a control unit 20 (see FIG. 2). The proximity sensor 22, the casing antenna, the film antenna, and the control unit 20 (see FIG. 2) are provided in the casing 12. The casing 12 has, for example, a rectangular parallelepiped shape, and the proximity sensor 22 is provided at one end portion in a longitudinal direction of the casing 12.

In the mobile communication terminal 10, an opening 13a of the casing 12 tends to be extended and the frame portion 13 tends to be narrowed in order to secure a display region (not illustrated) of the display unit 16, and the frame portion 13 has a narrow width.

In the mobile communication terminal 10, a display region (not illustrated) of the display unit 16 is located in the opening 13a. The opening 13a side of the mobile communication terminal 10 is also referred to as a viewer side.

The mobile communication terminal 10 is called, for example, a smartphone, a tablet, or a smart watch, and is also called a mobile device.

Here, an upper surface 12a of the casing 12 is a surface on one end portion side in a longitudinal direction of the casing 12 having a rectangular parallelepiped shape, and a lower surface 12b of the casing 12 is a surface on the other end portion side in the longitudinal direction. A side surface 12d of the casing 12 is a surface on the end portion side in a lateral direction orthogonal to the longitudinal direction. An upper portion of the casing 12 is one end portion in the longitudinal direction of the casing 12 having the rectangular parallelepiped shape, and a lower portion of the casing 12 is the other end portion in the longitudinal direction.

As illustrated in FIG. 1, in a case where the casing 12 is held by one hand H, the upper surface 12a is an end surface on an index finger side, and the lower surface 12b is an end surface on a little finger side. The side surface 12d is an end surface touched by a thumb or an end surface touched by a finger other than the thumb in a case where the casing 12 is held by one hand H.

The case where the casing 12 is held with one hand H is a case where the casing 12 is held with the one hand H without changing a relative positional relationship between an orientation of the casing 12 and the hand H. That is, the casing 12 is held with the one hand H without changing the orientation of the casing 12 in a state in which the casing 12 is put on the table.

As the casing antenna, for example, a first casing antenna 24 is provided on the upper surface 12a of the casing 12. A second casing antenna 26 is provided on the lower surface 12b of the casing 12.

The film antenna is provided on the display unit 16 and in a region of the opening 13a of the casing 12. Specifically, the film antenna is provided on the touch sensor unit 14 on the display unit 16 and at a position facing the opening 13a.

The mobile communication terminal 10 has a configuration other than the above-described configuration. The mobile communication terminal 10 includes, for example, a touch sensor unit 14, a display unit 16, a communication unit 18, and a control unit 20, as illustrated in FIG. 2.

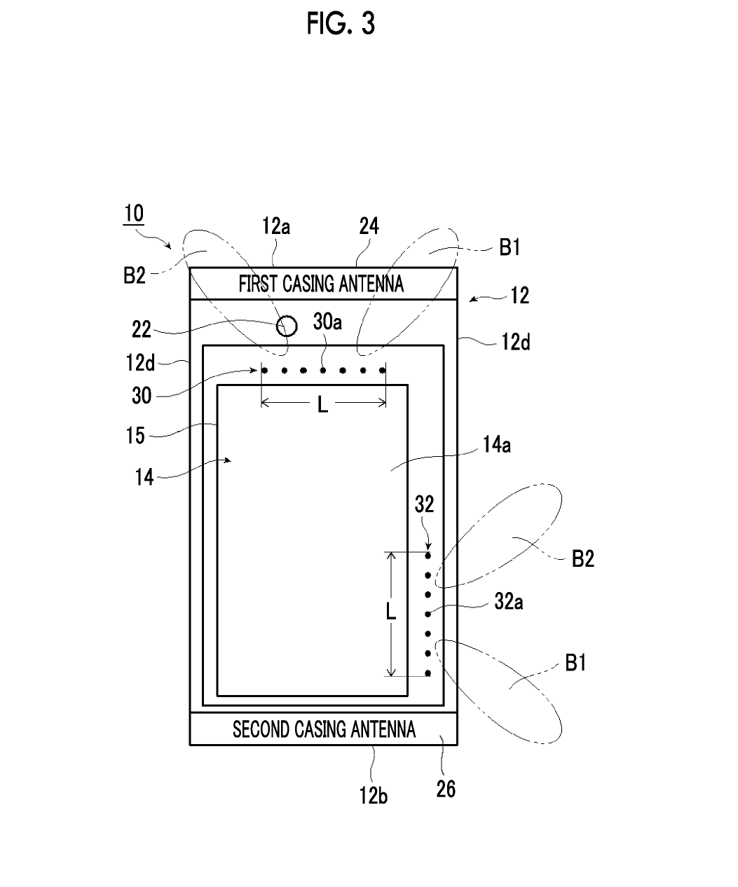

In the touch sensor unit 14, as will be described below in detail, in a case where a sensor unit 15 (see FIG. 3) is touched with a finger or the like, capacitance is changed at a touch position in the case of a capacitance type. A change in capacitance is detected by the control unit 20, and coordinates of the touch position are specified.

The control unit 20 includes a known control circuit (not illustrated) that is used for detection of a position of a general touch sensor. In a case where the touch sensor unit 14 is a capacitance type, a capacitance type control circuit is appropriately used, and in a case where the touch sensor unit 14 is a resistive film type, a resistive film type control circuit is appropriately used.

The touch sensor unit 14 is used together with the display unit 16 such as a liquid crystal display device and is provided on the display unit 16. Therefore, in the touch sensor unit 14, a region corresponding to a display image of the display unit 16 is transparent so as to cause an image displayed on the display unit 16 to be recognized.

A functional layer such as an antireflection layer may be provided to the touch sensor unit 14.

The touch sensor unit 14 is provided on the display unit 16, for example, via a transparent layer 17.

A configuration of the transparent layer 17 is not particularly limited as long as the transparent layer 17 is optically transparent, electrically insulated, and is able to stably fix the touch sensor unit 14. For the transparent layer 17, for example, an optically transparent resin (OCR: Optical Clear Resin) such as an optically transparent adhesive (OCA: Optical Clear Adhesive) or an ultra violet (UV) curable resin can be used. Further, the transparent layer 17 may be partially hollow.

A configuration in which the touch sensor unit 14 is provided to be spaced apart from the display unit 16 with a gap without the transparent layer 17 may be adopted. This gap is also called an air gap.

The display unit 16 is not particularly limited as long as the display unit 16 can display a predetermined image including a moving image or the like on a screen. For example, a liquid crystal display device, an organic electro luminescence (EL) display device, an electronic paper, or the like can be used.

The communication unit 18 transmits various types of data such as voice data, character data, and image data to the outside, and receives various types of data from the outside. Using the communication unit 18, a transmission signal with the various types of information described above can be transmitted and a reception signal can be received via an antenna, and information exchange with the outside such as an external device, that is, communication with the outside can be performed. A configuration of the communication unit 18 is not particularly limited as long as the communication unit 18 can transmit and receive the various types of data described above. A device used for the mobile communication terminal can be appropriately used. Further, the mobile communication terminal 10 includes, for example, a microphone and a speaker for exchange of voice data. In addition, for example, the communication unit 18 has a known configuration that is standardly used for a smartphone or the like. The communication unit 18 includes, for example, a memory that stores the various types of data described above, a circuit that converts the various types of data into a high-frequency transmission signal such as a radio frequency (RF) signal, a circuit that converts received signal into an available data format, a voice processing unit for calling, and a calculation unit for performing various calculations.

The proximity sensor 22 detects whether or not an object approaches the casing 12 in a non-contact manner, and outputs, for example, a detection signal to the control unit 20 in a case where detecting approaching of the object.

The proximity sensor 22 is provided, for example, in a frame portion 13 on the side of the upper surface 12a of the casing 12. It is possible to detect contact with an ear, even though contact with an ear occurs at the time of calling, by providing the proximity sensor 22 on the frame portion 13 on the side of the upper surface 12a of the casing 12.

For the proximity sensor 22, a known sensor can be appropriately used. For example, an infrared sensor using infrared rays can be used. The infrared sensor emits infrared rays and receives reflected light of the infrared rays to detect the presence of an object in a non-contact manner. The infrared sensor outputs a detection signal to the control unit 20, for example, in a case where receiving the reflected light of the infrared rays. For example, in a case where the control unit 20 receives the detection signal, the control unit 20 determines that a person is using the mobile communication terminal 10.

In addition to the infrared sensor, for example, an illuminance sensor that detects illuminance such as an intensity of light, brightness of the light, or luminance of the light can be used. By defining an illuminance threshold value in advance, the control unit 20 can determine that a person is using the mobile communication terminal 10 in a case where the illuminance obtained by the illuminance sensor is equal to or less than the threshold value.

Various antennas can be used for the first casing antenna 24 and the second casing antenna 26. For the first casing antenna 24 and the second casing antenna 26, for example, a linear antenna, a patch antenna, any antenna including a modification thereof, or the like can be used. In addition to these antennas, a dipole antenna and a monopole antenna can be used.

Further, a size of the first casing antenna 24 and the second casing antenna 26, such as a length, is determined by frequencies to be used. For example, in communication standard 5G (Generation) with a frequency of 24.25 to 86 GHz, a maximum length is 2 cm or less.

For example, two antennas including a first array antenna 30 and a second array antenna 32 are provided as film antennas. The first array antenna 30 is provided near the upper surface 12a of the casing 12 facing the front surface 14a of the touch sensor unit 14 and the opening 13a. The second array antenna 32 is provided near the one side surface 12d facing a front surface 14a of the touch sensor unit 14 and the opening 13a. The front surface 14a side of the touch sensor unit 14 is the viewer side of the mobile communication terminal 10.

The film antenna is not limited to the array antenna described above, and various antennas can be used according to usage, and frequencies to be used. From the viewpoint of directivity, an array antenna and a phased array antenna can be used.

The control unit 20 controls operations of the touch sensor unit 14, the display unit 16, and the communication unit 18. In a case where the detection signal of the proximity sensor 22 is received, that is, in a case where the person is using the mobile communication terminal 10, for example, the control unit 20 does not detect touch even in a case where the sensor unit 15 (see FIG. 3) of the touch sensor unit 14 is touched with a finger or the like. That is, touch sensitivity of the touch sensor unit 14 is turned off.

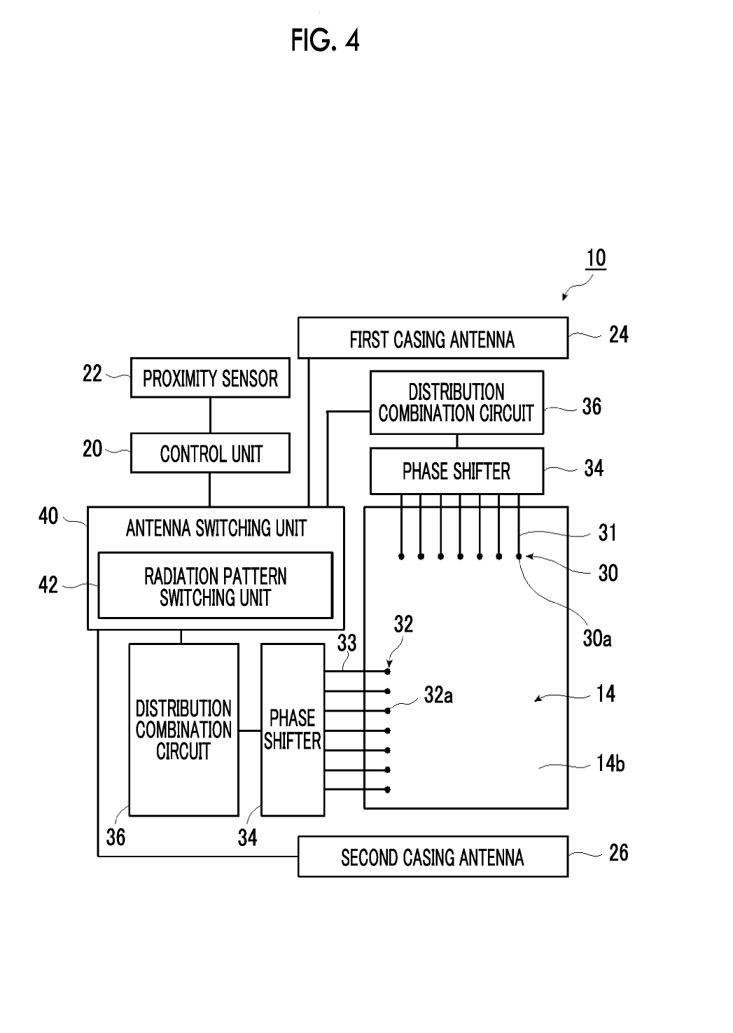

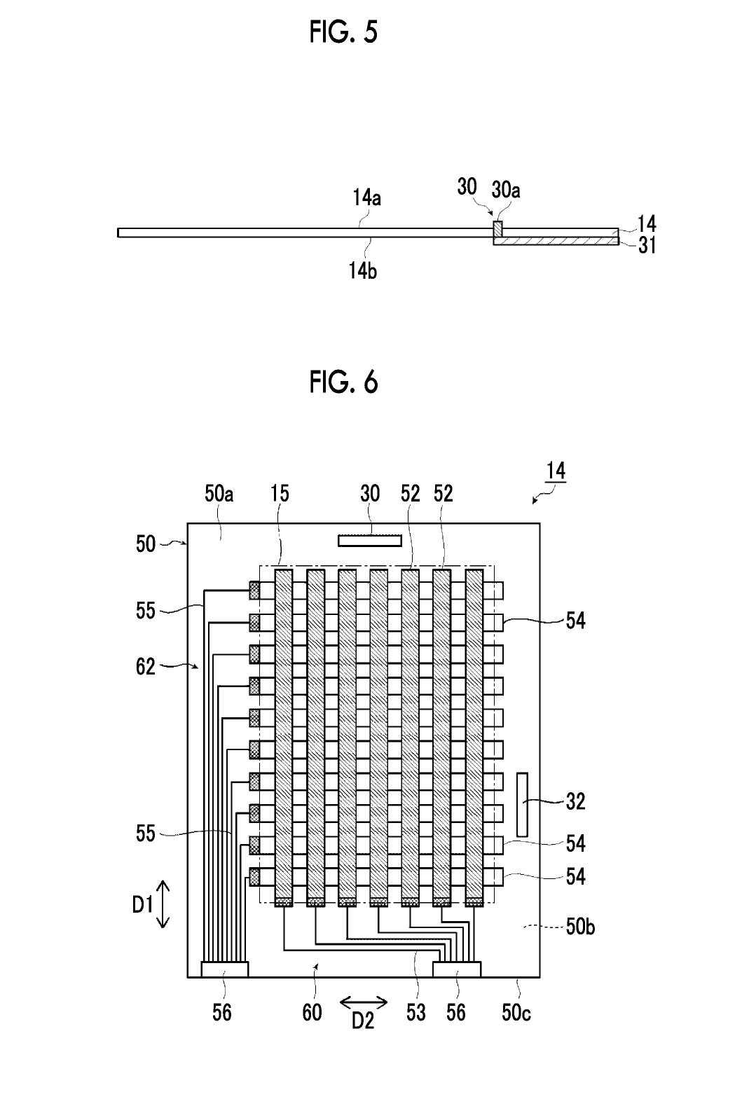

FIG. 3 is a schematic diagram illustrating a configuration on the viewer side of the mobile communication terminal according to the embodiment of the present invention, FIG. 4 is a schematic diagram illustrating a configuration on the back side of the mobile communication terminal according to the embodiment of the present invention, and FIG. 5 is a schematic cross-sectional view of the side surface side of the mobile communication terminal according to the embodiment of the present invention. In FIGS. 3 to 5, the same components as those of the mobile communication terminal 10 illustrated in FIG. 1 and FIG. 2 are denoted by the same reference numerals, and detailed description thereof will be omitted.

As illustrated in FIG. 3, in the mobile communication terminal 10, the first array antenna 30 and the second array antenna 32 are provided in the touch sensor unit 14. The first array antenna 30 and the second array antenna 32 have the same configuration, as antennas, although an arrangement position and an arrangement orientation are different.

The first array antenna 30 is an antenna that includes a plurality of antenna elements 30a and is fed with constant excitation conditions. In the first array antenna 30, the antenna elements 30a have a dot pattern in which the antenna elements 30a are regularly arranged on a straight line. In the first array antenna 30, a pattern on the viewer side, that is, a pattern on the front surface side of the casing 12 is the dot pattern.

The second array antenna 32 is an antenna that includes a plurality of antenna elements 32a and is fed with constant excitation conditions. In the second array antenna 32, the antenna elements 32a have a dot pattern in which the antenna elements 32a are regularly arranged on a straight line. In the second array antenna 32, a pattern on the viewer side, that is, a pattern on the front surface side of the casing 12 is the dot pattern.

For the first array antenna 30 and the second array antenna 32, a length L is determined according to the frequency to be used. For example, in the communication standard 5G (Generation) with a frequency of 24.25 to 86 GHz, the length L is 2 cm or less. Here, the length L is a length from one end to the other end between which the plurality of antenna elements 30a are arranged in the first array antenna 30, and a length from one end to the other end between which the plurality of antenna elements 32a are arranged in the second array antenna 32.

Using a plurality of antennas including the first casing antenna 24 and the second casing antenna 26 by providing the first array antenna 30 and the second array antenna 32, different data is transmitted from the first array antenna 30 and the second array antenna 32, and data is simultaneously received using the plurality of antennas. Thus, it is possible to realize high speed communication. For example, in a case where two antennas including the first array antenna 30 and the second array antenna 32 are used to transmit different signals from each other, double speed can be realized. This technique is called multi-input multi-output (MIMO).

As illustrated in FIGS. 4 and 5, in the first array antenna 30, each antenna element 30a is electrically connected to the phase shifter 34 via a wiring 31 provided on the back surface 14b of the touch sensor unit 14. The phase shifter 34 is electrically connected to the distribution combination circuit 36.

The back surface 14b side of the touch sensor unit 14 is a back side of the mobile communication terminal 10.

The phase shifter 34 is individually connected to each antenna element 30a and phase-shifts a phase of a high-frequency transmission signal output from the corresponding antenna element 30a. The amount of phase shift is controlled by the control unit 20, for example.

Shifting the phase of the transmission signal corresponds to changing the directivity of the first array antenna 30 formed of the plurality of antenna elements 30a. By controlling the amount of phase shift using the control unit 20, it is possible to radiate radio waves in a specific direction from the antenna. That is, beamforming can be realized by controlling the directivity of radio waves to be transmitted.

As described above, shifting the phase of the high-frequency transmission signal output from each antenna element 30a is equivalent to receiving radio waves from a range in a specific direction.

Further, reception signals received by the antenna elements 30a and phase-shifted by the phase shifter 34 are output to the distribution combination circuit 36 and combined.

Further, similarly to the antenna elements 30a described above, the phase shifter 34 phase-shifts the phase of the high-frequency transmission signal output from each antenna element 32a of the second array antenna 32. The amount of phase shift is controlled by the control unit 20, for example.

Further, reception signals received by the antenna elements 32a and phase-shifted by the phase shifter 34 are output to the distribution combination circuit 36 and combined.

As illustrated in FIG. 4, in the second array antenna 32, each antenna element 32a is electrically connected to the phase shifter 34 via wirings 33. The phase shifter 34 is electrically connected to the distribution combination circuit 36. Although not illustrated, the wirings 33 of the second array antenna 32 are also provided on the back surface 14b of the touch sensor unit 14 like the wiring 31 illustrated in FIG. 5.

Each distribution combination circuit 36 is electrically connected to the antenna switching unit 40. Further, the antenna switching unit 40 is electrically connected to the control unit 20.

The distribution combination circuit 36 distributes the high-frequency transmission signal sent from the radiation pattern switching unit 42, and feeds to the antenna elements 30a of the first array antenna 30 and the antenna elements 32a of the second array antenna 32. Further, the distribution combination circuit 36 combines the reception signals received by the first array antenna 30 and the second array antenna 32 and phase-adjusted by the phase shifter 34, and transmits the combined signal to the radiation pattern switching unit 42.

Both of feeding schemes of the first array antenna 30 and the second array antenna 32 are voltage feeding. The voltage feeding refers to a feeding scheme in which a voltage is maximized and a current is minimized at a feeding point.

The antenna switching unit 40 includes the radiation pattern switching unit 42.

The antenna switching unit 40 switches between the first casing antenna 24 and the second casing antenna 26 and the first array antenna 30 and the second array antenna 32 to be used. The antenna to be used is selected and the selected antenna is used. Switching between the antennas, that is, selection of the antennas to be used is performed by the control unit 20. The antennas selected by the control unit 20 are used for communication with the outside.

The radiation pattern switching unit 42 adjusts the radiation pattern of the transmission signal to be transmitted from the first array antenna 30 and the second array antenna 32. A known radiation pattern can be appropriately used. The radiation pattern switching unit 42 includes, for example, a plurality of ground conductor portions. The control unit 20 switches a connection between the feeding point of each antenna and each ground conductor portion, thereby changing a direction of a current flowing through a ground conductor. As a result, the radiation pattern of the transmission signal from the antenna is switched.

In FIG. 3, for example, in the first array antenna 30, the radiation pattern can be switched to a radiation beam B1 or a radiation beam B2. Further, in the second array antenna 32, the radiation pattern can be switched to the radiation beam B1 or the radiation beam B2.

Here, in a case where the frequency is tens of GHz, linearity is very high and diffraction is difficult, and there is concern that a transmission signal cannot be transmitted to a base station unless radio waves including the transmission signal is changed into a beam shape and a radiation direction is changed at the time of transmission. Since the directivity of the radio waves to be transmitted can be controlled as described above, the radio waves including the transmission signal is changed into the beam shape and the radiation direction is changed at the time of transmission, such that the transmission signal can be transmitted to the base station even in a case where the frequency is tens of GHz. Accordingly, information can be exchanged with the outside.

The radiation beam B1 and the radiation beam B2 described above are radiation beam in which directivity is controlled so that the spread is narrowed and a transmission direction of the radio waves is limited.

The first array antenna 30, the second array antenna 32, and the phase shifter 34 constitute a phased array antenna. The phased array antenna is capable of transmission and reception of radio waves having high linearity.

A specific directivity pattern can be obtained in the first array antenna 30 and the second array antenna 32 without the phase shifter 34, but orientation of the transmission direction of the radio waves cannot be changed. For example, radio waves in a specific orientation cannot be transmitted.

The first array antenna 30 and the second array antenna 32 are provided integrally with the sensor unit 15 in the touch sensor unit 14, but the present invention is not limited thereto. The first array antenna 30 and the second array antenna 32 may be separated from the touch sensor unit 14. For example, a configuration in which the first array antenna 30 and the second array antenna 32 are provided on the front surface 14a or the back surface 14b of the touch sensor unit 14 may be adopted.

It is preferable for a main component of the casing 12 to be a metal. By making the casing 12 with the metal, a design can be enhanced. In a case where the casing 12 is configured of a metal, reception sensitivity of the first casing antenna 24 and the second casing antenna 26 is degraded since the metal has a property of absorbing radio waves. On the other hand, in a case where the transmission signal is transmitted by radio waves, it is necessary to increase output of the radio waves in consideration of absorption. On the other hand, since the first array antenna 30 and the second array antenna 32 which are film antennas are provided in the opening 13a, the degradation of the reception sensitivity described above does not occur and the radio waves can be transmitted without an increase in the output of the radio waves.

The main component means that content is 85 mass % or more. Further, the metal constituting the casing 12 is, for example, aluminum. In a case where the aluminum is the main component, the content of the aluminum is 85 mass % or more.

Although the casing 12 is configured of a metal, the metal includes not only a single metal, but also an alloy of a plurality of metal elements.

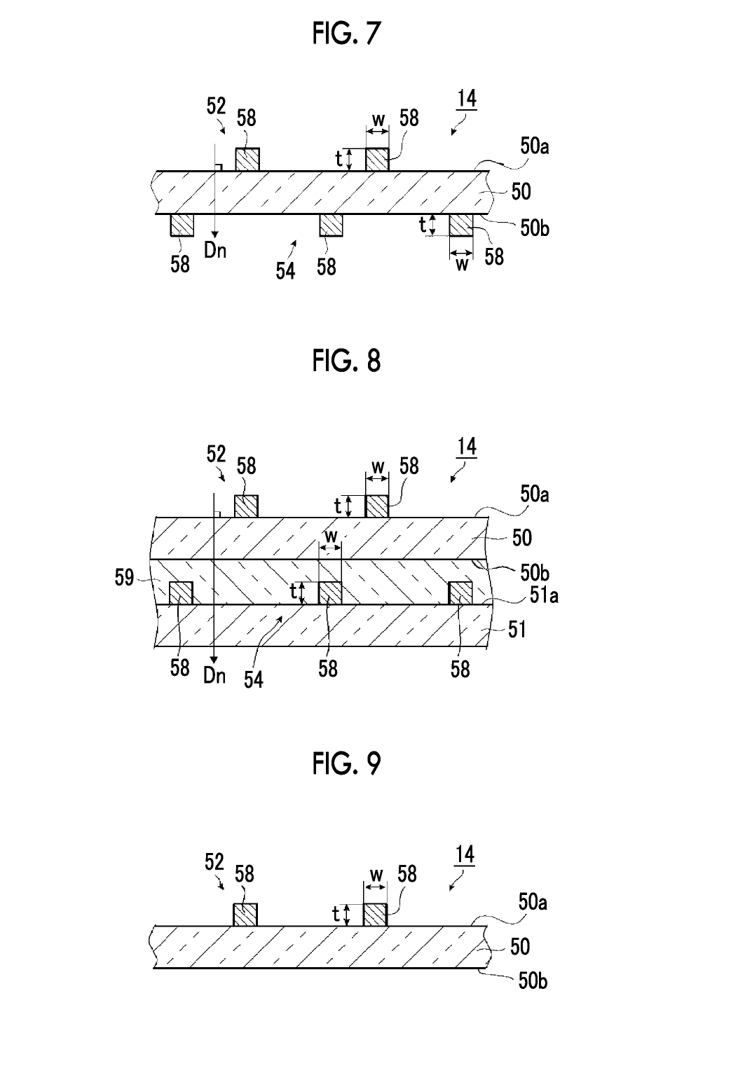

FIG. 6 is a schematic plan view illustrating a first example of the touch sensor unit of the mobile communication terminal according to the embodiment of the present invention, and FIG. 7 is a schematic cross-sectional view illustrating the first example of the touch sensor unit of the mobile communication terminal of the embodiment of the present invention.

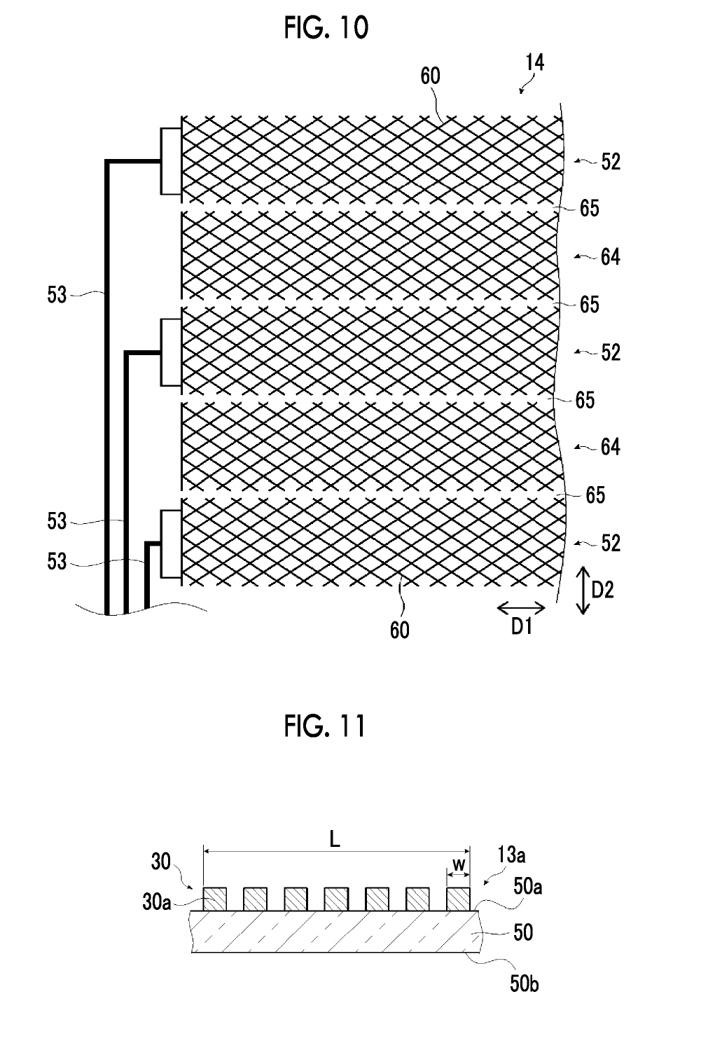

FIG. 8 is a schematic cross-sectional view illustrating a second example of the touch sensor unit of the mobile communication terminal according to the embodiment of the present invention, FIG. 9 is a schematic cross-sectional view illustrating a third example of the touch sensor unit of the mobile communication terminal of the embodiment of the present invention, and FIG. 10 is a schematic diagram illustrating a fourth example of the touch sensor unit of the mobile communication terminal according to the embodiment of the present invention.

The touch sensor unit 14 includes, for example, a transparent substrate, a detection electrode provided on at least one of surfaces of the transparent substrate, and a peripheral wiring portion electrically connected to the detection electrode provided on at least one of surfaces of the transparent substrate.

Specifically, in the touch sensor unit 14, a plurality of first detection electrodes 52 extending along a first direction D1 and arranged in parallel in a second direction D2 perpendicular to the first direction D1 are formed on the front surface 50a of the transparent substrate 50, and a plurality of first peripheral wirings 53 electrically connected to the plurality of first detection electrodes 52 are arranged close to each other, as illustrated in FIG. 6. The plurality of first peripheral wirings 53 are integrated into one terminal 56 at one side 50c of the transparent substrate 50. The plurality of first peripheral wirings 53 are collectively referred to as a first peripheral wiring portion 60.

A plurality of second detection electrodes 54 extending in a second direction D2 and arranged in parallel in the first direction D1 are formed on the back surface 50b (see FIG. 7) of the transparent substrate 50, and a plurality of second peripheral wirings 55 electrically connected to the second detection electrodes 54 are arranged close to each other. The plurality of second peripheral wirings 55 are integrated into one terminal 56 at the one side 50c of the transparent substrate 50. The plurality of second peripheral wirings 55 are collectively referred to as a second peripheral wiring portion 62.

The second detection electrode 54 is disposed in a layered shape at least partially overlapped and spaced with respect to the first detection electrode 52. More specifically, the second detection electrode 54 is disposed to be at least partially overlapped with the first detection electrode 52 in a case where viewed from a direction Dn perpendicular to one surface of the transparent substrate 50 (see FIG. 7). A lamination direction in which the first detection electrode 52 and the second detection electrode 54 are overlapped with each other is the same direction as the vertical direction Dn (see FIG. 7). The plurality of first detection electrodes 52 and the plurality of second detection electrodes 54 constitute a sensor unit 15.

As illustrated in FIGS. 6 and 7, the first detection electrodes 52 are provided on the front surface 50a of one transparent substrate 50 and the second detection electrodes 54 are provided on the back surface 50b, such that it is possible to reduce a deviation of a positional relationship between the first detection electrodes 52 and the second detection electrodes 54 even in a case where the transparent substrate 50 shrinks.

Each of the first detection electrodes 52 and the second detection electrodes 54 is configured of a fine metal wire 58 and has a mesh pattern having an opening. The mesh pattern of the first detection electrodes 52 and the second detection electrodes 54 will be described below in detail.

The first peripheral wirings 53 and the second peripheral wirings 55 may be formed of the fine metal wires 58 or may be formed of conductive wirings having line widths and thicknesses different from the fine metal wires 58. The first peripheral wiring 53 and the second peripheral wiring 55 may be formed of, for example, strip-like conductors. Each component of the touch sensor unit 14 will be described below in detail.

The touch sensor unit 14 is not limited to the capacitive touch sensor as long as the touch sensor unit 14 has a mesh pattern configured of the fine metal wires 58 as described above, and may be a resistive film type touch sensor. In a resistive film type touch sensor, the plurality of first detection electrodes 52 and the plurality of second detection electrodes 54 constitute the sensor unit 15.

In the touch sensor unit 14, a region in which the plurality of first detection electrodes 52 and the plurality of second detection electrodes 54 overlap each other in a plan view on the transparent substrate 50 is the sensor unit 15. The sensor unit 15 is formed of the first detection electrode 52 and the plurality of second detection electrodes 54.

The sensor unit 15 is a region in which contact of a finger or the like, that is, touch can be detected in a capacitive touch sensor. The sensor unit 15 is placed on the display region (not illustrated) of the display unit 16 (see FIG. 2), and the touch sensor unit 14 is disposed on the display unit 16. Therefore, the sensor unit 15 is also a visible region. In a case where an image is displayed on the display region, the sensor unit 15 becomes an image display region.

In the transparent substrate 50, for example, a decorative portion (not illustrated) having a light shielding function is provided in a region in which the first peripheral wiring portion 60 and the second peripheral wiring portion 62 are formed.

By providing the decorative portion, the first peripheral wiring portion 60 and the second peripheral wiring portion 62 are invisible.

A configuration of the decorative portion is not particularly limited as long as the first peripheral wiring portion 60 and the second peripheral wiring portion 62 can be invisible, and a known decorative layer can be used. Various printing methods such as a screen printing method, a gravure printing method, and an offset printing method, a transfer method, and a deposition method can be used for formation of the decorative portion.

Invisible means that the first peripheral wiring portion 60 and the second peripheral wiring portion 62 cannot be visually recognized. In a case where ten observers see an object, no one being able to see the object is said to be invisible.

The touch sensor unit 14 is not particularly limited to those illustrated in FIGS. 6 and 7, and for example, a configuration in which one detection electrode is provided on one transparent substrate 50 or 51 as in the touch sensor unit 14 illustrated in FIG. 8 may be adopted. The touch sensor unit 14 has a configuration in which a transparent substrate 51 may be laminated, in which the first detection electrode 52 is provided on the front surface 50a of one transparent substrate 50, and the second detection electrode 54 is provided on a front surface 51a via the adhesive layer 59 on the back surface 50b of the transparent substrate 50. The transparent substrate 51 has the same configuration as the transparent substrate 50. For the adhesive layer 59, the same material as the transparent layer 17 described above can be used. In FIG. 8, a lamination direction in which the first detection electrode 52 and the second detection electrode 54 are overlapped is the same direction as the vertical direction Dn.

Further, the touch sensor unit 14 has a configuration in which the two detection electrodes including the first detection electrode 52 and the second detection electrode 54 are provided, but the present invention is not limited thereto. For example, a configuration in which the first detection electrode 52 is provided on the front surface 50a of one transparent substrate 50 as illustrated in FIG. 9 may be adopted.

Further, the touch sensor unit 14 may be configured to have a dummy electrode electrically insulated from the detection electrode. In this case, a configuration in which a dummy electrode 64 electrically insulated from the first detection electrode 52 is provided between the plurality of first detection electrodes 52 in the second direction D2, as illustrated in FIG. 10 may be adopted.

The first detection electrode 52 and the dummy electrode 64 are arranged with a gap 65 therebetween. The dummy electrode 64 is electrically insulated from the first detection electrode 52 with the gap 65 and does not function as a detection electrode.

The dummy electrode 64 has the same mesh pattern as that of the first detection electrodes 52 except that the dummy electrode 64 is electrically insulated from the first detection electrode 52 with the gap 65. The dummy electrode 64 can be formed by removing only a region of the mesh pattern which becomes the gap 65 instead of removing all the mesh pattern between the first detection electrodes 52 at the time of fabrication of the first detection electrode 52 after the mesh pattern is fabricated.

In FIG. 10, the first detection electrode 52 has been described as an example. However, a configuration in which the dummy electrode 64 described above is provided for the second detection electrode 54, similar to the first detection electrode 52 may be adopted.

As illustrated in FIG. 11, the first array antenna 30 is provided in a region corresponding to the opening 13a on the front surface 50a of the transparent substrate 50. Further, although not illustrated, the second array antenna 32 is provided in a region corresponding to the opening 13a on the front surface 50a of the transparent substrate 50, similar to the first array antenna 30. The antenna element 30a and the antenna element 32a are small and hard to be visually recognized, and each of the first array antenna 30 and the second array antenna 32 have low visibility. Therefore, even in a case where the first array antenna 30 and the second array antenna 32 are provided in the opening 13a, visual recognition thereof is suppressed. Thus, it is possible to provide the antennas without affecting the visibility. Accordingly, the antenna can be provided in a place in which there is no influence of radio wave absorption in the casing 12 made of a metal and the radio waves are hardly shielded by the human body.

A line width w of the antenna element 30a and the antenna element 32a is preferably 0.5 to 5.0 μm, an upper limit value is more preferably 3 μm or less, and the upper limit value is more preferably 1.5 μm or less. In a case where the line width w is 0.5 to 5.0 μm, the visibility of the first array antenna 30 and the second array antenna 32 can be degraded. In a case where the line width w exceeds 5.0 μm, the antenna element 30a of the first array antenna 30 and the antenna element 32a of the second array antenna 32 become easy to see. On the other hand, in a case where the line width w is less than 0.5 μM, the surface resistances of the antenna element 30a and the antenna element 32a are increased, heat is generated at the time of transmission and reception of radio waves, and characteristics of the first array antenna 30 and the second array antenna 32 deteriorate. In a case where the upper limit value is preferably 3 μm or less and more preferably 1.5 μm or less, both visibility of the antenna element 30a and the antenna element 32a and reduction of surface resistance can be satisfied.

The line width w of the antenna element 30a and the antenna element 32a can be measured using, for example, an optical microscope, a laser microscope, a digital microscope, or the like.

A film thickness of the antenna element 30a and the antenna element 32a is preferably 0.1 to 10 μm, more preferably 0.3 to 5 μm, and most preferably 0.5 to 4 μm from the viewpoint of visibility from an oblique direction.

In a case where the antenna element 30a and the antenna element 32a are blackened, it is not necessary to worry about the antenna element 30a and the antenna element 32a being visually recognized from an oblique direction due to the film thickness, that is, visibility. For blackening treatment, a generally known blackening treatment can be used. Tellurium-containing hydrochloric acid treatment described in JP2015-082178A can also be used.

In the mobile communication terminal 10, the casing antennas and the film antennas are provided as antennas and are appropriately used such that the antenna suitable for communication with the outside can be always used. Therefore, even in a case where there is an antenna in which radio waves are shielded due to contact of a human body or the like, the radio waves can be transmitted and received and communication with the outside can be maintained. Accordingly, stable communication with the outside becomes possible. Particularly, even in a case where the casing 12 is configured of, for example, a metal having a large effect of absorbing radio waves, communication with the outside can be maintained and stable communication with the outside becomes possible.

In the mobile communication terminal 10, in a case where the detection signal is output from the proximity sensor 22 to the control unit 20, transmission and reception in the first casing antenna 24 are stopped by the antenna switching unit 40 via the control unit 20 in a case where it is determined that a human body is present in the designated range. That is, the use of the first casing antenna 24 is stopped. At least one antenna among the first array antenna 30 and the second array antenna 32 can be used by the antenna switching unit 40. That is, a state in which transmission and reception are possible comes. In this case, communication with the outside can be maintained, and stable communication with the outside becomes possible.

In the mobile communication terminal 10, the antenna may be switched according to orientation of a posture of the mobile communication terminal 10. In the mobile communication terminal 10, a posture of the mobile communication terminal 10 can be known using sensors such as an acceleration sensor and a tilt sensor. Therefore, in a case where the upper surface 12a of the mobile communication terminal 10 is upward, the control unit 20 determines that the side surface 12d is held, and the antenna switching unit 40 performs switching so that at least one of the first casing antenna 24, the second casing antenna 26, or the first array antenna 30 is used.

Further, in a case where one side surface 12d is upward, the control unit 20 determines that the mobile communication terminal 10 is held sideways, and the antenna switching unit 40 performs switching so that at least one of the first array antenna 30 or the second array antenna 32 is used instead of the first casing antenna 24 and the second casing antenna 26. Since the first array antenna 30 is provided on the upper surface 12a side, it is preferable to use the second array antenna 32.

An antenna suitable for each posture of the mobile communication terminal 10 may be set in advance and stored in the control unit 20 on the basis of the arrangement of the antennas. Accordingly, the control unit 20 can easily determine the antenna to be used according to the posture of the mobile communication terminal 10. In this case, communication with the outside can be maintained and stable communication with the outside becomes possible.

Next, a second embodiment of the mobile communication terminal 10 will be described.

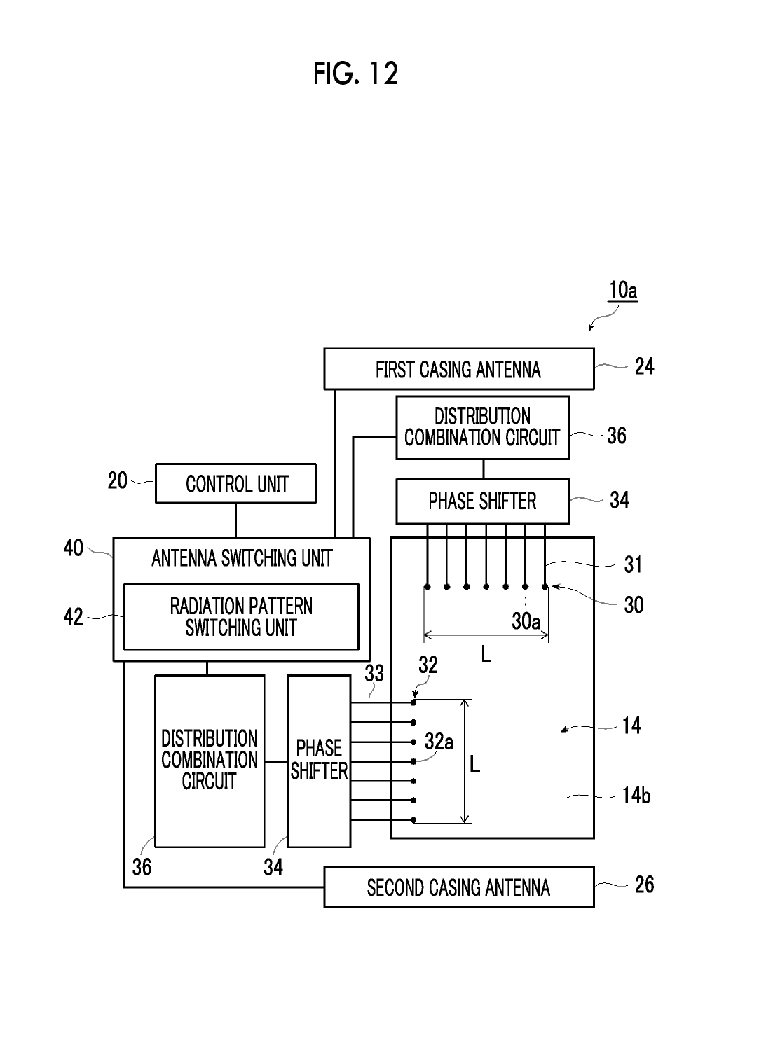

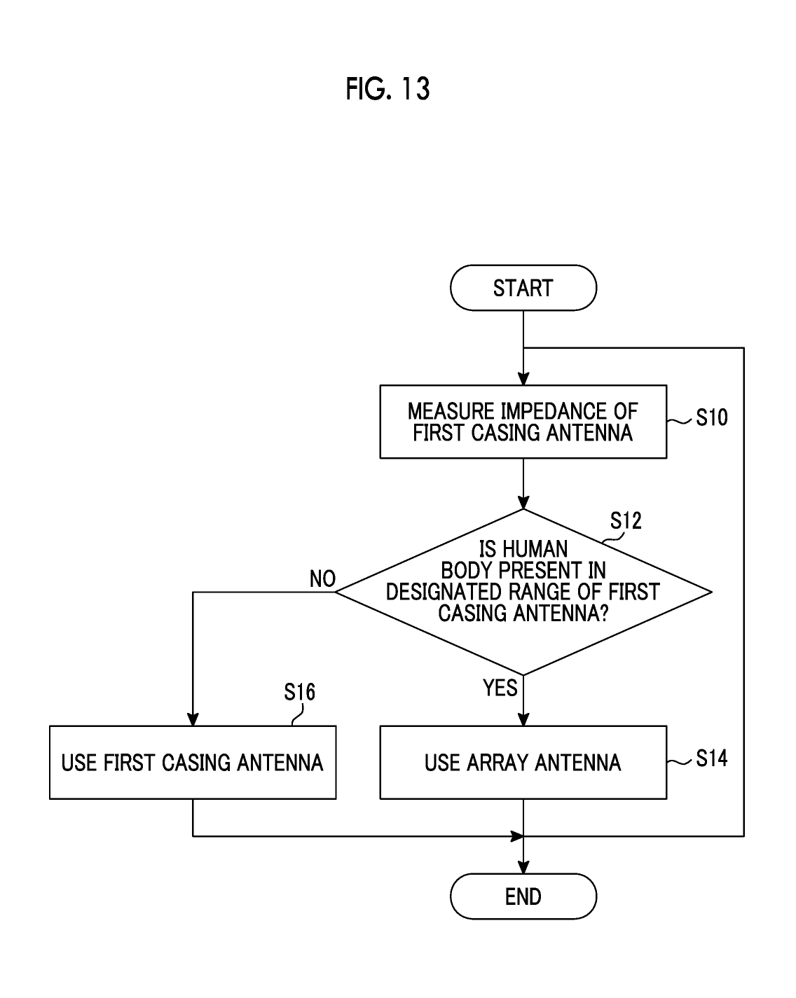

FIG. 12 is a schematic diagram illustrating a mobile communication terminal according to the second embodiment of the present invention, and FIG. 13 is a flowchart showing switching between antennas.

In the mobile communication terminal 10a illustrated in FIG. 12, the same components as those of the mobile communication terminal 10 illustrated in FIGS. 1 to 5 are denoted by the same reference numerals, and detailed description thereof will be omitted.

The mobile communication terminal 10a illustrated in FIG. 12 differs from the mobile communication terminal 10 illustrated in FIGS. 1 to 5 in that the proximity sensor 22 is not provided, the mobile communication terminal 10a has a function of measuring impedance of the first casing antenna 24, and the control unit 20 determines whether or not a human body is present in a designated range using the impedance of the first casing antenna 24. Other configurations are the same as those of the mobile communication terminal 10 illustrated in FIGS. 1 to 5.

In the mobile communication terminal 10a illustrated in FIG. 12, the first casing antenna 24 constitutes a proximity sensor.

In the mobile communication terminal 10, the antennas are switched on the basis of a detection signal of the proximity sensor 22, whereas in the mobile communication terminal 10a, the antennas are switched as illustrated in FIG. 13 using the impedance of the first casing antenna 24.

Measurement of the impedance of the first casing antenna 24 is not particularly limited as long as the impedance can be measured, and known measurement can be appropriately used. For example, a directional coupler is used for measurement of the impedance. A directional coupler that is used to obtain real-time impedance information, for example, a measurement value of impedance of an antenna is known. The measurement value of the impedance is output to the control unit 20, and the control unit 20 determines whether or not a human body is present in the designated range.

As illustrated in FIG. 13, first, the control unit 20 measures the impedance of the first casing antenna 24 (step S10).

Then, a measurement value of the impedance of the first casing antenna 24 is output to the control unit 20, and the control unit 20 determines whether or not a human body is present in the designated range using the measurement value of the impedance (step S12).

A relationship between the measurement value of the impedance of the first casing antenna 24 and a distance to the human body is obtained and stored in the control unit 20 in advance, for example. In step S12, the control unit 20 determines whether or not a human body is present in the designated range on the basis of the measurement value of the impedance of the first casing antenna 24.

In a case where it is determined in step S12 that the human body is present in the designated range, the antenna switching unit 40 stops transmission and reception in the first casing antenna 24 via the control unit 20. That is, the use of the first casing antenna 24 is stopped. At least one of the first array antenna 30 and the second array antenna 32 can be used by the antenna switching unit 40, and transmission and reception are performed using at least one of the first array antenna 30 or the second array antenna 32 (step S14).

On the other hand, in a case where it is determined in step S12 that there is no human body in the designated range, the first casing antenna 24 is continuously used (step S16).

For example, a time interval for measuring the impedance of the first casing antenna 24 is set in advance, steps S10 and S12 described above are repeatedly performed, and an antenna suitable for transmission and reception is always used. In this case, communication with the outside can be maintained, and stable communication with the outside becomes possible.

The impedance of the first casing antenna 24 is used for switching between the antennas, but a function called a hover of the touch sensor unit 14 can also be used as the proximity sensor. In this case, a range of the upper surface 12a side of the casing 12 is set in the touch sensor unit 14 in advance, and in a case where a face approaches the casing 12 at the time of calling or the like, the face is detected by the touch sensor unit 14, and the control unit 20 can determine that a human body is present in the designated range.

Further, the antennas may be switched by using reception sensitivity of the antennas. In this case, the reception sensitivity of the first casing antenna 24 or the second casing antenna 26 is measured. The reception sensitivity can be specified by measuring an intensity of radio waves to be received.

A configuration in which the reception sensitivity is measured for each of the first casing antenna 24 and the second casing antenna 26, and in a case where the reception sensitivity is smaller than a preset value, the control unit 20 causes at least one of the first array antenna 30 or the second array antenna 32 to be used, via the antenna switching unit 40 may be adopted.

Although the first array antenna 30 and the second array antenna 32 are used as film antennas, the present invention is not limited thereto and other configurations may be used. For the antennas, various types of antennas can be used according to a specification or the like. For example, a dipole antenna, a monopole antenna, and a loop antenna can be used. In this case, it is preferable for a feeding scheme to be voltage feeding. The voltage feeding is a scheme of feeding a voltage from an end portion, for example, in the case of a ½ wavelength dipole antenna.

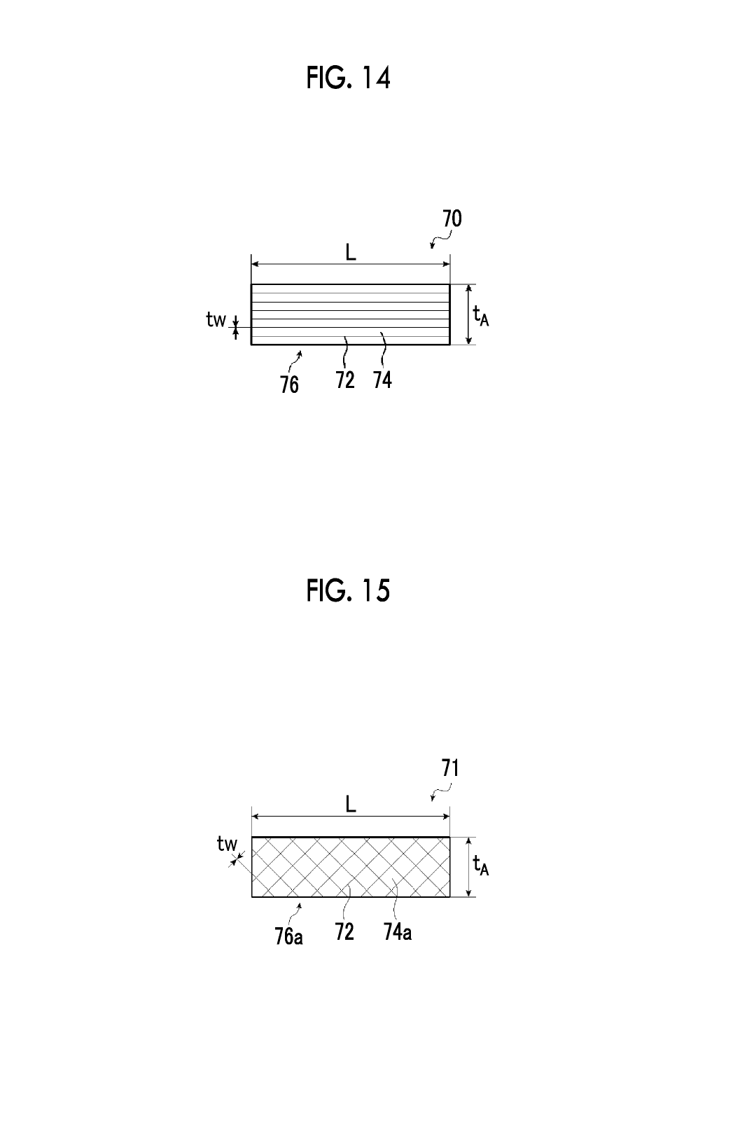

FIG. 14 is a schematic diagram illustrating a first example of the antenna, and FIG. 15 is a schematic diagram illustrating a second example of the antenna.

The antenna 70 illustrated in FIG. 14 has a pattern 76 including a plurality of openings 74 configured of fine metal wires 72.

Since the fine metal wire 72 has the same thickness or the like, and has the same composition as the fine metal wire 58 as described above except that the line width tw is different from that of the fine metal wire 58, detailed description thereof will be omitted.

The antenna 70 is, for example, a monopole antenna and has a rectangular shape having a length of L and a width of t_{A}. The plurality of openings 74 have a rectangular shape and have the same shape and size. The length L of the antenna 70 is determined by the frequency to be used as described above. In the antenna 70, for example, in the communication standard 5G (Generation) with a frequency of 24.25 to 86 GHz, the length L is 2 cm or less. The length L is a maximum length of the antenna 70.

In the antenna 70, the line width tw of the fine metal wire 72 is 0.5 to 5.0 μm, an upper limit value is preferably 3 μm or less, and the upper limit value is more preferably 1.5 μm or less. In a case where the line width tw is 0.5 to 5.0 μm, the visibility of the antenna 70 can be degraded and the line appearance of the antenna 70 can be suppressed. In a case where the line width tw exceeds 5.0 μm, the fine metal wire 72 of the antenna 70 becomes easy to see. On the other hand, in a case where the line width tw is less than 0.5 μm, surface resistance of the antenna 70 becomes great, heat is generated in a case where radio waves are transmitted and received, and characteristics of the antenna 70 deteriorate. The upper limit value is preferably 3 μm or less and more preferably 1.5 μm or less, such that both the visibility of the fine metal wire 72 and the reduction of the surface resistance can be satisfied.

The line width tw of the fine metal wire 72 can be measured using, for example, an optical microscope, a laser microscope, or a digital microscope.

A film thickness of the fine metal wire 72 is preferably 0.1 to 10 μM, more preferably 0.3 to 5 μm, most preferably 0.5 to 4 μm from the viewpoint of visibility from an oblique direction.

In a case where the fine metal wire 72 is blackened, it is not necessary to worry about the fine metal wire 72 being visually recognized from an oblique direction due to the film thickness, that is, visibility. For blackening treatment, a generally known blackening treatment can be used. Tellurium-containing hydrochloric acid treatment described in JP2015-082178A can also be used.

The antenna 70 has an opening ratio of 70% or more. In a case where the opening ratio is 70% or more, the visibility of the antenna 70 can be degraded, and the line appearance of the fine metal wire 72 of the antenna 70 can be suppressed. On the other hand, in a case where the opening ratio is less than 70%, the fine metal wire 72 of the antenna 70 becomes easy to see.

The opening ratio of the antenna 70 is defined by an unoccupied area ratio of a fine conductor wire in a range of the length L of the antenna 70×the width t_{A}.

For the opening ratio, the pattern 76 is imaged by an imaging element so as to obtain a captured image of the pattern 76, and then, the captured image is binarized so as to extract the fine metal wire 72. A ratio of the fine metal wire 72 to an area of the length L×line width tw of the antenna 70 is obtained, such that the opening ratio can be obtained.

Surface resistance of the antenna 70 is preferably 9 Ω/sq. or less.

Since it is preferable for the surface resistance to be low from the characteristics required for the antenna 70, the surface resistance of the fine metal wire 72 is 9 Ω/sq. or less. A lower limit value of the surface resistance of the antenna 70 is preferably 0.001)/sq. The surface resistance of the antenna 70 is preferably 0.01 to 5 Ω/sq. In a case where the surface resistance of the antenna 70 exceeds 9 Ω/sq., heat is generated at the time of transmission and reception of radio waves, and the characteristics of the antenna 70 deteriorate. Further, in a case where the surface resistance exceeds 9 Ω/sq., the substrate is likely to be deformed in a case where the substrate is formed of a resin due to heat generation during transmission and reception of radio waves.

It is preferable for the fine metal wire 72 to be made of, for example, copper. In this case, not only copper alone but also copper containing a binder may be used.

The surface resistance is a resistance value obtained by cutting the antenna 70 that is a measurement target with a width of 10 mm, attaching a conductive copper tape to both ends thereof so that a length of the antenna 70 became 10 mm, and measuring resistance at both of the ends using a 34405A multimeter available from Agilent.

Surface resistance of the first array antenna 30 and the second array antenna 32 is preferably 9 Ω/sq. or less.

A shape of the opening portion of the antenna 70 is not particularly limited to the pattern 76 illustrated in FIG. 14 as long as the line width tw, the opening ratio, and the surface resistance described above are satisfied. For example, the shape may be a pattern 76a having a diamond-shaped opening portion 74a, as in of the antenna 71 illustrated in FIG. 15. The opening portion may be a triangle, a square, a parallelogram, a pentagon, a hexagon, a random polygon, or the like, in addition to the rectangle and the diamond, and a part of a side constituting the polygon may be a curve. However, the pattern 76 illustrated in FIG. 14 is preferable in consideration of heat dissipation of the antenna 70 and the antenna 71 at the time of using of the antenna 70 and the antenna 71.

In a case where a plurality of antennas 70 and a plurality of antennas 71 are provided, all of the antennas may be the same type of antennas or different types of antennas, and are not particularly limited. In a case where there are a plurality of antennas, the opening ratios of the respective antennas may be the same, or the opening ratios may be different from each other. Further, the opening ratio of each antenna may be the same as or be different from the opening ratio of the touch sensor unit 14. Thus, the opening ratio of the touch sensor unit 14 is different from the opening ratio of each antenna, and three or more regions in which opening ratios are different from each other may be configured.

It is preferable for the antenna 70 and the antenna 71 to be separated from an end portion of the touch sensor from the viewpoint of reception sensitivity. In this case, it is preferable for the antenna 70 and the antenna 71 to be provided inside the touch sensor unit 14. Specifically, the antenna 70 and the antenna 71 are separated by, preferably, 0.5 cm or more from the end portion of the touch sensor, more preferably by 1 cm or more, and most preferably by 2 cm or more. In this case, the separation means separation at a shortest straight distance between the touch sensor end portion and the antenna 70 and the antenna 71.

Further, the antenna 70 and the antenna 71 may be provided to overlap with the first detection electrode 52 and the second detection electrode 54 of the sensor unit 15 at an upper end portion or a side end portion of the touch sensor unit 14. In this case, the antenna 70 and the antenna 71 are provided in a region in which the first detection electrode 52, the first peripheral wiring 53 or the second detection electrode 54, and the second peripheral wiring 55 are not formed, on the same plane as the first detection electrode 52 or the second detection electrode 54.

Hereinafter, each member of the touch sensor unit 14 will be described.

First, the fine metal wires 58 of the first detection electrode 52 and the second detection electrode 54 will be described.

A line width w of the fine metal wire 58 is not particularly limited, but in a case where the fine metal wire 58 is applied as the first detection electrode 52 and the second detection electrode 54, the line width w is preferably equal to or greater than 0.5 μm and smaller than or equal to 5 μm. An upper limit value is more preferably 3 μm or less. The upper limit value is more preferably 1.5 μm or less. In a case where the line width w of the fine metal wire 58 is in the above range, the first detection electrode 52 and the second detection electrode 54 having a low resistance can be relatively easily formed.

In a case where the fine metal wire 58 is applied as a peripheral wiring, the line width w of the fine metal wire 58 is preferably 500 μm or less, more preferably 50 μm or less, and particularly preferably 30 μm or less. In a case where the line width w is in the above range, a low-resistance peripheral wiring can be relatively easily formed.

In a case where the fine metal wires 58 are used as peripheral wirings, it is possible to form the same mesh pattern as that of the first detection electrodes 52 and the second detection electrodes 54. In that case, the line width w is not particularly limited. The line width w is preferably 10 μm or less, more preferably 5 μm or less, further preferably 2 μm or less, particularly preferably 1.3 μm or less, and preferably 0.5 μm or more. In a case where the line width w is in the above range, low-resistance peripheral wirings can be relatively easily formed. The peripheral wirings in the mesh pattern is preferable in that it is possible to increase uniformity of resistance reduction due to irradiation of the detection electrode and the peripheral wirings in a step of performing irradiation with pulsed light from a xenon flash lamp in a case where the first detection electrode 52 and the second detection electrode 54 are formed, and in addition, peel strength of the first detection electrode 52, the second detection electrode 54, and the peripheral wirings can be made constant in a case where an adhesive layer is bonded, and an in-plane distribution can be made small.

A thickness t of the fine metal wire 58 is not particularly limited. The thickness t is preferably 1 to 200 μm, more preferably 50 μm or less, more preferably 20 μm or less, particularly preferably 0.01 to 9 μm, and most preferably 0.05 to 5 μm. In a case where the thickness t is in the above range, a detection electrode with low resistance and excellent durability can be formed relatively easily.

For the line width w of the fine metal wire 58 and the thickness t of the fine metal wire 58, a cross sectional image of the touch sensor unit 14 including the fine metal wire 58 is acquired, the cross sectional image is input to a personal computer and displayed on a monitor, a horizontal line is drawn at each of two places defining the line width w of the fine metal wires 58 described above on the monitor, and a length between the horizontal lines is obtained. Accordingly, the line width w of the fine metal wire 58 can be obtained. Further, a horizontal line is drawn at each of two places defining the thickness t of the fine metal wire 58, and a length between the horizontal lines is obtained. Accordingly, the thickness t of the fine metal wire 58 can be obtained.

<Transparent Substrate>

Since the transparent substrate 50 and the transparent substrate 51 are the same, only the transparent substrate 50 will be described. A type of transparent substrate 50 is not particularly limited as long as the transparent substrate 50 can support the first detection electrode 52, the first peripheral wiring 53, the second detection electrode 54, and the second peripheral wiring 55. However, particularly, a plastic film is preferable.

As specific examples of a material constituting the transparent substrate 50, a plastic film having a melting point of about 290° C. or less, such as polyethylene terephthalate (PET) (258° C.), polycycloolefin (134° C.), polycarbonate (250° C.), acrylic resin (128° C.), polyethylene naphthalate (PEN) (269° C.), polyethylene (PE) (135° C.), polypropylene (PP) (163° C.), polystyrene (230° C.), polyvinyl chloride (180° C.), polyvinylidene chloride (212° C.), and triacetylcellulose (TAC) (290° C.), is preferable. Particularly, PET, the polycycloolefin, and polycarbonate are preferable. Numbers in parentheses are melting points.

A total light transmittance of the transparent substrate 50 is preferably 85% to 100%. The total light transmittance is measured using, for example, “Plastics—A Method of Obtaining Total Light Transmittance and Total Light Reflectance” defined by JIS (Japanese Industrial Standards) K 7375: 2008.

One preferred aspect of the transparent substrate 50 is a treated substrate subjected to at least one treatment selected from a group consisting of atmospheric pressure plasma treatment, corona discharge treatment, and ultraviolet irradiation treatment. A hydrophilic group such as an OH group is introduced into a surface of the treated transparent substrate 50 by performing the above-described treatment, thereby further improving adhesion between the first detection electrode 52, the first peripheral wiring 53, the second detection electrode 54 and the second peripheral wiring 55 and the transparent substrate 50.

Among the above-described treatments, the atmospheric pressure plasma treatment is preferred in that the adhesion between the first detection electrode 52, the first peripheral wiring 53, the second detection electrode 54, and the second peripheral wiring 55 and the transparent substrate 50 is further improved.

As another preferable aspect of the transparent substrate 50, it is preferable to have an undercoat layer containing a polymer on a surface on which the first detection electrode 52, the first peripheral wiring 53, the second detection electrode 54, and the second peripheral wiring 55 are provided. By forming a photosensitive layer for forming the first detection electrode 52, the first peripheral wiring 53, the second detection electrode 54, and the second peripheral wiring 55 on this undercoat layer, adhesion between the first detection electrode 52, the first peripheral wiring 53, the second detection electrode 54, and the second peripheral wiring 55 and the transparent substrate 50 is further improved.

A method of forming the undercoat layer is not particularly limited. For example, there is a method of coating a substrate with a composition for formation of an undercoat layer containing a polymer and performing a heat treatment as necessary. A solvent may be contained in the composition for formation of the undercoat layer, as necessary. A type of solvent is not particularly limited. However, a solvent used in a composition for formation of a photosensitive layer to be described below is exemplified. Further, as the composition for formation of an undercoat layer containing a polymer, a latex containing fine particles of a polymer may be used.

A thickness of the undercoat layer is not particularly limited. However, the thickness of the undercoat layer is preferably 0.02 to 0.3 μm, and more preferably, 0.03 to 0.2 μm in that the adhesion between the first detection electrode 52, the first peripheral wiring 53, the second detection electrode 54, and the second peripheral wiring 55 and the transparent substrate 50 is further excellent.

As necessary, the touch sensor unit 14 may include, for example, an antihalation layer as another layer between the transparent substrate 50, the first detection electrode 52, and the second detection electrode 54, in addition to the undercoat layer described above.

<Fine Metal Wire>

The fine metal wire 58 has electrical conductivity, and is configured of, for example, a metal or an alloy. The fine metal wire 58 can be configured of, for example, a copper wire or a silver wire. A metal silver is preferably contained in the fine metal wire 58, but a metal other than the metal silver, such as gold or copper may be contained in the fine metal wire 58. Further, it is preferable for the fine metal wire 58 to contain a polymer binder such as metal silver and gelatin, which is suitable for formation of a mesh pattern.

The fine metal wire 58 is not limited to the fine metal wire configured of the metal described above or alloy. For example, the fine metal wire 58 may contain metal oxide particles, a metal paste such as a silver paste and a copper paste, and metal nanowire particles such as silver nanowires and copper nanowires.

Further, in a case where the fine metal wire 58 is configured of the same material as the antenna, it is preferable for the fine metal wire 58 to be configured of copper.

The fine metal wire 58 may be configured of a plurality of metal layers. Further, the fine metal wire 58 may be subjected to blackening treatment. Further, a visibility control layer configured of, for example, CuO may be provided on the fine metal wire 58.

The mesh pattern of the first detection electrode 52 and the second detection electrode 54 is not particularly limited. It is preferable for mesh pattern to be a triangle such as an equilateral triangle, an isosceles triangle, or a right triangle, a rectangle such as a square, a rectangle, a diamond, a parallelogram, or a trapezoid, a polygon such as a hexagon or an octagon, a circle, an ellipse, a star, or the like, or a geometric figure obtained by combining these. The mesh pattern is formed by combining a large number of cells formed in a lattice shape using fine metal wires. Specifically, the mesh pattern is intended to be a pattern formed by combining a plurality of square lattices configured of intersecting fine metal wires 58 formed on the same surface of the transparent substrate. The mesh pattern may be a combination of lattices in a similar shape or a congruent shape, or a combination of lattices in different shapes. Although a length of one side of the lattice is not particularly limited, the length is preferably 50 to 500 μm since it is difficult for the lattice to be visually recognized, and more preferably 150 to 500 μm. In a case where a length of a side of a unit lattice is in the above range, it is possible to maintain good transparency and it is possible to visually recognize a display without feeling uncomfortable in a case where the lattice is attached to a front surface of the display device.

Further, the mesh pattern of the first detection electrode 52 and the second detection electrode 54 may be configured of a combination of curves. For example, circular arcs may be combined to form a cell in a circular or elliptical lattice shape. As the circular arc, for example, an arc of 90° or a circular arc of 180° can be used.

The mesh pattern of the first detection electrode 52 and the second detection electrode 54 may be a random pattern. The random pattern is, for example, a pattern obtained by randomly combining polygons having different types and sizes. In addition, the random pattern is, for example, a pattern in which at least one of an arrangement pitch, angle, length, or shape is not constant for a polygon constituting the pattern. Here, the polygon may be a substantially polygonal, and part or all of sides of the polygon may be curved.

In this case, for example, the random pattern is a pattern in which angles of a regular diamond shape are preserved, a pitch is irregular, and an opening portion is a parallelogram. Further, the random pattern may be a pattern in which an opening portion is a diamond and angles of the diamond shape are irregular. A distribution of the irregularity may be a normal distribution or a uniform distribution.

Next, a method of forming the fine metal wires 58 (see FIG. 7) will be described. The method of forming the fine metal wires 58 is not particularly limited as long as the fine metal wires 58 can be formed on the transparent substrate 50 and the transparent substrate 51. For example, a plating method, a silver salt method, a deposition method, a printing method, or the like can be appropriately used as a method of forming the fine metal wires 58.

A method of forming the fine metal wires 58 using the plating method will be described. For example, the fine metal wires 58 can be configured of a metal plating film formed on an underlayer through electroless plating on an electroless plating underlayer. In this case, the fine metal wires 58 is formed by forming a catalyst ink containing at least fine metal particles in a pattern on a base material, and then, immersing the base material in an electroless plating bath to form a metal plating film. More specifically, a method of fabricating a metal film base material described in JP2014-159620A can be used. Further, the fine metal wires 58 is formed by forming a resin composition having a functional group capable of interacting with at least a metal catalyst precursor in a pattern on the base material, applying a catalyst or a catalyst precursor, immersing the base material into an electroless plating bath, and forming a metal plating film. More specifically, the method of fabricating a metal film base material described in JP2012-144761A can be applied.

The plating method may be only electroless plating, or electroplating may be performed after the electroless plating. An additive method can be used for the plating method.

The additive method is a method of forming a thin metal wire by performing plating treatment or the like on only a portion on a transparent substrate in which the thin metal wire is desired to be formed. From the viewpoint of productivity or the like, the additive method is preferable.

A subtractive method can also be used for formation of the fine metal wire 58. The subtractive method is a method of forming a thin metal wire by forming a conductive layer on a transparent substrate and removing unnecessary portions through etching treatment such as chemical etching treatment.

A method of forming the fine metal wires 58 using a silver salt method will be described. First, the fine metal wire 58 can be formed by performing exposure treatment using an exposure pattern serving as the fine metal wire 58 on a silver salt emulsion layer containing silver halide and then performing a development process. More specifically, a method of fabricating a fine metal wire described in JP2015-22597A can be used.

A method of forming the fine metal wire 58 using a deposition method will be described. First, the fine metal wire 58 can be formed by forming a copper foil layer through deposition and forming a copper wiring from a copper foil layer using a photolithography method. An electrolytic copper foil can be used in addition to a deposited copper foil, as the copper foil layer. More specifically, the step of forming a copper wiring described in JP2014-029614A can be used.

A method of forming the fine metal wires 58 using the printing method will be described. First, the fine metal wires 58 can be formed by coating a substrate with a conductive paste containing a conductive powder in the same pattern as that of the fine metal wires 58, and then performing heat treatment. The pattern formation using the conductive paste is performed, for example, using an inkjet method or a screen printing method. More specifically, a conductive paste described in JP2011-028985A can be used as the conductive paste.

Examples of the method of forming the fine metal wires 58 may include a method of forming fine metal wires through electroplating using a semi-additive method to be described below, in addition to the above-described method.

The semi-additive method will be described. For example, the semi-additive method includes the following steps.

(1) A step of forming a first metal film on a substrate (a first metal film forming step)

(2) A step of forming a resist film including an opening in a region in which a fine metal wire is formed on the first metal film (a resist film forming step)

(3) A step of forming a second metal film in the opening and on the first metal film (a second metal film forming step)

(4) A step of removing the resist film (a resist film removing step)

(5) A step of removing a part of the first metal film using the second metal film as a mask and forming a conductive portion configured of fine metal wires (a conductive portion forming step)

Hereinafter, a procedure of each step will be described in detail.

[First Metal Film Forming Step]

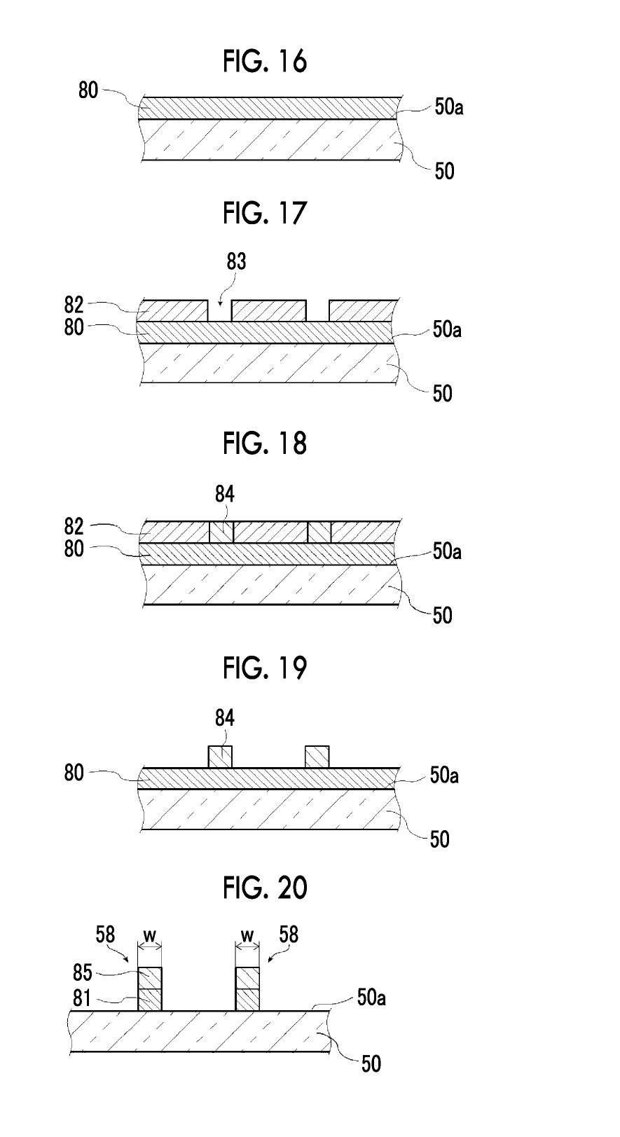

FIG. 16 is a schematic cross-sectional view illustrating the first metal film forming step. By performing the first metal film forming step, the first metal film 80 is formed on the front surface 50a of the transparent substrate 50. The first metal film 80 functions as at least one of a seed layer or an underlying metal layer (an underlying adhesive layer).

FIG. 16 shows a case where the first metal film 80 is one layer, but the present invention is not limited thereto. For example, the first metal film 80 may be a laminated structure formed by laminating two or more layers. In a case where the first metal film 80 is a laminated structure, it is preferable for a lower layer on the side of the transparent substrate 50 to function as an underlying metal layer (an underlying adhesive layer), and it is preferable for an upper layer on the side of a second metal film 84 to be described below to function as a seed layer.

Since a material of the first metal film 80 is the same as the material in the fine metal wire 58 described above, description thereof will be omitted.

The thickness of the first metal film 80 is not particularly limited. Generally, the thickness is preferably 30 to 300 nm and, more preferably 40 to 100 nm.

In a case where the thickness of the first metal film 80 is 300 nm or less, manufacturing suitability in the conductive portion forming step (particularly, an etching process) to be described below is improved. Therefore, the fine metal wire 58 has more excellent in-plane uniformity of the line width.

The method of forming the first metal film 80 is not particularly limited, and a known formation method can be used. In particular, a sputtering method or a deposition method is preferable in that a layer having a denser structure is easily formed.

[Resist Film Forming Step]

FIG. 17 is a schematic cross-sectional view illustrating the resist film forming step. By performing this step, the resist film 82 is formed on the first metal film 80.

The resist film 82 includes an opening 83 in a region in which the fine metal wire 58 (see FIG. 20) is formed. The region of the opening 83 in the resist film 82 can be appropriately adjusted according to the region in which the fine metal wire is desired to be placed. Specifically, in a case where the fine metal wire disposed in a mesh shape is to be formed, the resist film 82 having a mesh-like opening is formed. Normally, the opening 83 is formed in a fine line shape according to the fine metal wire.

A line width of the opening 83 is preferably less than 2.0 μm, more preferably 1.5 μm or less, and still more preferably 1.0 μm or less. By setting the line width of the opening 83 to be less than 2.0 μm, it is possible to obtain the fine metal wire 58 having a fine line width. In particular, in a case where the line width of the opening 83 is 1.5 μm or less, the line width of the fine metal wire 58 to be obtained becomes finer, and it is difficult for the fine metal wire 58 to be visually recognized from the user.

The line width of the opening 83 is intended to be a width of a fine line portion in a direction orthogonal to an extending direction of the fine line portion of the opening 83. Through the respective steps to be described below, the fine metal wire 58 having a line width corresponding to the line width of the opening 83 are formed.

A method of forming the resist film 82 on the first metal film 80 is not particularly limited, and a known resist film forming method can be used. An example of the method may include a method including the following steps.

(a) A step of coating the first metal film 80 with a composition for formation of a resist film to form a composition layer for formation of a resist film.

(b) A step of exposing the composition for formation of a resist film through a photomask having a pattern-like opening.

(c) A step of developing the composition for formation of a resist film after exposure to obtain the resist film 82.

At least one timing among between step (a) and step (b), between step (b) and step (c), and after step (c), at least one of the step of heating the composition layer for formation of a resist film and the step of heating the resist film 82 may be further performed.

Step (a)

Any known positive-type radiation-sensitive composition can be used as the composition for formation of a resist film that can be used in step (a) described above.

The method for coating the first metal film 80 with the composition for formation of a resist film is not particularly limited, and a known coating method can be used.

Examples of the method of coating with the composition for formation of a resist film include a spin coating method, a spray method, a roller coating method, and a dipping method.

After the composition layer for formation of a resist film is formed on the first metal film 80, the composition layer for formation of a resist film may be heated. Through heating, unnecessary solvent remaining in the composition layer for formation of a resist film can be removed so as to make the composition layer for formation of a resist film uniform.

The method for heating the composition layer for formation of a resist film is not particularly limited, and may be, for example, a method of heating the transparent substrate 50.

A temperature for the heating described above is not particularly limited. Generally, the temperature is preferably 40 to 160° C.

A thickness of the composition layer for formation of a resist film is not particularly limited, and a thickness after drying is generally preferably from 1.0 to 5.0 μm.

Step (b)

The method of exposing the composition layer for formation of a resist film is not particularly limited, and a known exposure method can be used.

An example of the method of exposing the composition layer for formation of a resist film may include a method of irradiating the composition layer for formation of a resist film with actinic rays or radiation through a photomask having a patterned opening. An exposure dose is not particularly limited. Generally, it is preferable for irradiation to be performed with 10 to 50 mW/cm₂ for one to ten seconds.

A line width of the pattern-like opening included in the photomask used in step (b) is generally preferably less than 2.0 μm, more preferably 1.5 μm or less, and still more preferably 1.0 μm or less.

The composition layer for formation of a resist film after exposure may be heated. A temperature for heating is not particularly limited. Generally, the temperature is preferably 40 to 160° C.

Step (c)

The method for developing the composition layer for formation of a resist film after exposure is not particularly limited, and a known developing method can be used.

Examples of the known developing method may include a method using a developing solution containing an organic solvent or an alkali developing solution.

Examples of the developing method include a dipping method, a paddle method, a spray method, and a dynamic dispensing method.

Further, the resist film 82 after development may be cleaned using a rinsing liquid. The rinsing liquid is not particularly limited, and a known rinsing liquid can be used. Examples of the rinsing liquid may include an organic solvent and water.

[Second Metal Film Forming Step]

FIG. 18 is a schematic cross-sectional view illustrating the second metal film forming step. Through this step, the second metal film 84 is formed in the opening 83 of the resist film 82 and on the first metal film 80. The second metal film 84 is formed so as to fill the opening 83 of the resist film 82.

It is preferable for the second metal film 84 to be formed using a plating method.

As the plating method, a known plating method can be used. Specific examples of the plating method may include an electrolytic plating method and an electroless plating method. From the viewpoint of productivity, the electrolytic plating method is preferable.

A metal contained in the second metal film 84 is not particularly limited, and a known metal can be used.

The second metal film 84 may contain, for example, a metal such as copper, chromium, lead, nickel, gold, silver, tin, or zinc, and an alloy thereof.

In particular, it is preferable for the second metal film 84 to contain copper or an alloy thereof in that the fine metal wire 58 is more excellent in conductivity. Further, it is preferable for a main component of the second metal film 84 to be copper in that the fine metal wire 58 is more excellent in conductivity.

The content of the metal constituting the main component in the second metal film 84 is not particularly limited. Generally, the content is preferably 50 to 100 mass %, more preferably 90 to 100 mass %.

A line width of the second metal film 84 is a line width corresponding to the line width of the opening 83 of the resist film 82. Specifically, the line width is preferably less than 2.0 μm, more preferably 1.5 μm or less, and more preferably 1.0 μm or less. A lower limit value of the line width of the second metal film 84 is not particularly limited. Generally, the lower limit value is preferably 0.3 μm or more.

A line width of the second metal film 84 is intended to be a width of the fine line in a direction orthogonal to an extending direction of a fine line portion of the second metal film 84.

A thickness of the second metal film 84 is not particularly limited. Generally, the thickness is preferably 300 to 2000 nm and more preferably 300 to 1000 nm.

[Resist Film Removing Step]

FIG. 19 is a schematic cross-sectional view illustrating a resist film removing step. In this step, the resist film 82 is removed, and a laminate in which the transparent substrate 50, the first metal film 80, and the second metal film 84 are formed in this order is obtained.

A method of removing the resist film 82 is not particularly limited, and an example of the method may include a method of removing the resist film 82 using a known resist film removing solution.

Examples of the resist film removing solution may include an organic solvent and an alkaline solution.

A method of causing the resist film removing solution to come into contact with the resist film 82 is not particularly limited. Examples of the method include a dipping method, a paddle method, a spray method, and a dynamic dispensing method.

[Conductive Portion Forming Step]

FIG. 20 is a schematic cross-sectional view illustrating the conductive portion forming step. According to this step, a part of the first metal film 80 which is the region in which the second metal film 84 is not formed is removed, and the fine metal wire 58 is formed on the front surface 50a of the transparent substrate 50.

The fine metal wire 58 includes a first metal layer 81 corresponding to the first metal film 80 and a second metal layer 85 corresponding to the second metal film 84. The first metal layer 81 and the second metal layer 85 are laminated in this order from the front surface 50a side of the transparent substrate 50.

A method of removing a part of the first metal film 80 is not particularly limited, and a known etching solution can be used.

Examples of the known etching solution include a ferric chloride solution, a cupric chloride solution, an ammonia alkali solution, a sulfuric acid-hydrogen peroxide mixture solution, and a phosphoric acid-hydrogen peroxide mixture solution. Among them, an etching solution in which it is easy for the first metal film 80 to be dissolved and it is difficult for the second metal film 84 to be dissolved as compared with the first metal film 80 may be selected appropriately.

In a case where the first metal film 80 is a laminated structure as described above, an etching solution may be changed for each layer to perform multi-step etching.

A line width of the first metal layer 81 is preferably less than 2.0 μm, more preferably 1.5 μm or less, and still more preferably 1.0 μm or less. A lower limit value of the line width of the first metal layer 81 is not particularly limited. Generally, the lower limit value is preferably 0.3 μm or more.

The line width of the first metal layer 81 is intended to be a width of the fine line in a direction orthogonal to an extending direction of the fine line portion of the first metal layer 81.

Since a line width of the second metal layer 85 is the same as the line width of the second metal film 84 described above, description thereof will be omitted.

The line width w of the fine metal wire 58 is less than 2.0 μm, preferably 1.5 μm or less, and more preferably 1.0 μm or less. A lower limit value of the line width w of the fine metal wires 58 is not particularly limited. Generally, the lower limit value is preferably 0.3 μm or more.

In a case where the line width w of the fine metal wire 58 is less than 2.0 μm, it is further difficult for the user of the touch panel to visually recognize the fine metal wire 58.

The line width w of the fine metal wire 58 means a maximum line width among the line widths of the first metal layer 81 and the second metal layer 85 in a cross section in a width direction of the fine metal wire 58 (a cross section orthogonal to an extending direction of the fine metal wire).

Next, each portion of the first array antenna 30, the second array antenna 32, the antenna 70, and the antenna 71 will be described.

A composition of the antenna element 30a of the first array antenna 30, the antenna element 32a of the second array antenna 32, and the fine metal wire 72 is a metal containing an alloy. The antenna element 30a, the antenna element 32a, and the fine metal wire 72 will be described in greater detail. A composition of the antenna element 30a, the antenna element 32a, and the fine metal wire 72 includes a single metal element or a plurality of metal elements. An oxide of 20 mass % or more is not contained. The composition including the plurality of metal elements may include an alloy or may include a plurality of types of metals that are independently present. Further, the fine metal wire 72 is not limited to the fine metal wire configured of only a metal element, and may include metal particles and a binder. This metal particle may be configured of a single metal element or may be an alloy consisting of a plurality of metal elements. Further, a plurality of types of single metal elements may be used. The antenna element 30a, the antenna element 32a, and the fine metal wire 72 do not include those having conductivity with an oxide such as an indium tin oxide (ITO) or those having conductivity with a resin or the like.

The antenna element 30a, the antenna element 32a, and the fine metal wire 72 are not limited to those formed of a metal or an alloy or those containing a metal or an alloy and a binder. For example, the antenna element 30a, the antenna element 32a, and the fine metal wire 72 can be formed using a method of forming a thin metal wire by performing plating treatment or the like on only a portion in which the fine metal wire to be described below in detail is desired to be formed. In this case, the antenna element 30a, the antenna element 32a, and the fine metal wire 72 are formed of a plating layer and a metal layer, and a layer to be plated is covered with a metal layer. In addition, an aspect in which, although not illustrated, the metal layer is disposed only on an upper surface of the layer to be plated may be adopted as the antenna element 30a, the antenna element 32a, and the fine metal wire 72.

In an aspect in which the layer to be plated is covered with a metal layer, the metal layer has metal luster, but the layer to be plated looks black in a case where the antenna element 30a, the antenna element 32a, and the fine metal wire 72 are viewed from the back surface 50b side of the transparent substrate 50. Therefore, in a case where the antenna element 30a, the antenna element 32a, and the fine metal wire 72 are viewed from the side of the layer to be plated, visibility of the antenna element 30a, the antenna element 32a, and the fine metal wire 72 is degraded, as compared with a case where the antenna element 30a, the antenna element 32a, and the fine metal wire 72 are viewed from the front surface 50a side of the transparent substrate 50, that is, viewed from the metal layer side. That is, it is difficult for the antenna element 30a, the antenna element 32a, and the fine metal wire 72 to see.

The antenna element 30a, the antenna element 32a, and the fine metal wire 72 can have the same configuration as the fine metal wire 58 of the detection electrode described above. In this case, the visibility of the fine metal wire 58 can be degraded. That is, it is difficult for the fine metal wires 58 to see. Therefore, in the touch sensor unit 14, the visibility of the fine metal wire 58 can be degraded.

Since the first array antenna 30, the second array antenna 32, the antenna 70, and the antenna 71 have low visibility as described above, the first array antenna 30, the second array antenna 32, the antenna 70, and the antenna 71 being visually recognized in the touch sensor unit 14 is suppressed even in a case where the first array antenna 30, the second array antenna 32, the antenna 70, and the antenna 71 are provided in a region corresponding to the opening 13a of the casing 12 in the touch sensor unit 14. Therefore, it is possible to provide the antennas in the region corresponding to the opening 13a of the casing 12, and to reduce occupancy of a volume of the mobile communication terminal 10 of the first array antenna 30, the second array antenna 32, the antenna 70, and the antenna 71.

Further, the first array antenna 30, the second array antenna 32, the antenna 70, and the antenna 71 have low surface resistances, and good sensitivity can be obtained.

From this, it is possible to provide the first array antenna 30, the second array antenna 32, the antenna 70, and the antenna 71 having good sensitivity in the region corresponding to the opening 13a of the casing 12. Therefore, it is possible to narrow the frame portion 13 of the casing 12. Thus, even in a case where a display region of the mobile communication terminal 10 is small, it is possible to provide the first array antenna 30, the second array antenna 32, the antenna 70, and the antenna 71, and to contribute to miniaturization of the mobile communication terminal 10.

Further, since the first array antenna 30, the second array antenna 32, the antenna 70, and the antenna 71 can be provided in the region corresponding to the opening 13a of the casing 12 and can be provided to overlap with the first detection electrode 52 and the second detection electrode 54 as described above, a degree of freedom of a position at which the first array antenna 30, the second array antenna 32, the antenna 70, and the antenna 71 are provided is high. Here, as described above, in a case where the frame portion 13 is held by hand, the sensitivity of the first array antenna 30, the second array antenna 32, the antenna 70, and the antenna 71 is greatly degraded due to contact with the hand in a case where the first array antenna 30, the second array antenna 32, the antenna 70, and the antenna 71 are near the frame portion 13. However, since the first array antenna 30, the second array antenna 32, the antenna 70, and the antenna 71 can also be provided at a center of the touch sensor unit 14, it is also possible to suppress degradation of the sensitivity of the first array antenna 30, the second array antenna 32, the antenna 70, and the antenna 71.

Moreover, since the first array antenna 30, the second array antenna 32, the antenna 70, and the antenna 71 occupy a small region, a plurality of first array antenna 30, a plurality of second array antennas 32, a plurality of antennas 70, and a plurality of antennas 71 can be provided in the region corresponding to the opening 13a of the casing 12.

In a case where the first array antenna 30, the second array antenna 32, the antenna 70, and the antenna 71 are formed on the same plane as the first detection electrode 52 and the first peripheral wiring 53, it is possible to collectively form the first detection electrode 52, the first peripheral wiring 53, the first array antenna 30, the second array antenna 32, the antenna 70, and the antenna 71 by setting the exposure pattern as a pattern of each portion. Accordingly, it is possible to simplify a manufacturing process and to suppress a manufacturing cost. Moreover, the first detection electrode 52, the first peripheral wiring 53, the first array antenna 30, the second array antenna 32, the antenna 70, and the antenna 71 can be formed of the same material. Further, these can be formed to have the same thickness.

Further, in a case where the first detection electrode 52 and the first peripheral wiring 53, the second detection electrode 54, and the second peripheral wiring 55 are formed by exposing both surfaces of the transparent substrate 50 at the same time, the second detection electrode 54 and the second peripheral wiring 55 can also be collectively formed. Thus, it is possible to further enhance production efficiency and to further suppress a manufacturing cost. Further, the second detection electrode 54 and the second peripheral wiring 55 can be formed to have the same thickness.

Here, the same materials mean that types and contents of composition components match each other. This matching requires the same types of composition components and allows a range of ±10% for the content. Further, for example, in a case where the same material is used for formation in the same process, the material is the same. The composition and the content can be measured, for example, using a fluorescent X-ray analysis device. It is obvious that the first detection electrode 52, the first peripheral wiring 53, the second detection electrode 54, the second peripheral wiring 55, the first array antenna 30, the second array antenna 32, the antenna 70, and the antenna 71 are not limited to those to be formed of the same material, but these can be formed of different materials with different thicknesses.

Further, the first array antenna 30, the second array antenna 32, the antenna 70, and the antenna 71 are provided on the same transparent substrate 50 as the touch sensor unit 14, the present invention is not limited thereto, and the first array antenna 30, the second array antenna 32, the antenna 70, and the antenna 71 may be configured as a single unit.

The present invention is basically configured as described above. The mobile communication terminal of the present invention has been described above in detail, but the present invention is not limited thereto. It is obvious that various improvements or modifications may be made without departing from the spirit of the present invention.

### EXPLANATION OF REFERENCES

10, 10a: mobile communication terminal
12: casing
12a: upper surface
12b: lower surface
12d: side surface
13: frame portion
13a: opening
14: touch sensor unit
14a, 50a, 51a: front surface
14b, 50b: back surface
15: sensor unit
16: display unit
17: transparent layer
18: communication unit
20: control unit
22: proximity sensor
24: first casing antenna
26: second casing antenna
30: first array antenna
30a, 32a: antenna element
31, 33: wiring
32: second array antenna
34: phase shifter
36: distribution combination circuit
40: antenna switching unit
42: radiation pattern switching unit
50: transparent substrate
50c: one side
51: transparent substrate
52: first detection electrode
53: first peripheral wiring
54: second detection electrode
55: second peripheral wiring
56: terminal
58: fine metal wire
59: adhesive layer
60: first peripheral wiring portion
62: second peripheral wiring portion
64: dummy electrode
65: gap
70, 71: antenna
72: fine metal wire
74, 74a: opening
76, 76a: pattern
80: first metal film
81: first metal layer
82: resist film
83: opening
84: second metal film
85: second metal layer
D1: first direction
D2: second direction
Dn: direction
H: hand
S10: step
S12: step
S14: step
S16: step
t: thickness
t_{A}: width
tw: line width
W: line width

What is claimed is:

1. A mobile communication terminal comprising:
a casing;
a proximity sensor;
a film antenna;
a casing antenna; and
a control unit,
wherein the proximity sensor, the film antenna, the casing antenna, and the control unit are provided in the casing.

2. The mobile communication terminal according to claim 1,
wherein a main component of the casing is a metal.

3. The mobile communication terminal according to claim 2,
wherein the metal is aluminum.

4. The mobile communication terminal according to claim 1,
wherein the film antenna is an array antenna.

5. The mobile communication terminal according to claim 4, further comprising:
a phase shifter connected to the array antenna.

6. The mobile communication terminal according to claim 1,
wherein the film antenna is a phased array antenna.

7. The mobile communication terminal according to claim 1,
wherein the film antenna has a dot pattern.

8. The mobile communication terminal according to claim 1,
wherein the proximity sensor is an infrared sensor using infrared rays.

9. The mobile communication terminal according to claim 1,
wherein the proximity sensor includes the casing antenna.

10. The mobile communication terminal according to claim 1,
wherein the casing antenna has a maximum length of 2 cm or less.

11. The mobile communication terminal according to claim 1,
wherein the film antenna is formed of a fine metal wire having a line width of 3 μm or less.

12. The mobile communication terminal according to claim 11,
wherein the film antenna has the line width of 1.5 μm or less.

13. The mobile communication terminal according to claim 1,
wherein the film antenna has a maximum length of 2 cm or less.

14. The mobile communication terminal according to claim 1,
wherein the casing has a rectangular parallelepiped shape, and
the proximity sensor is provided at one end portion in a longitudinal direction of the casing.

15. The mobile communication terminal according to claim 1,
wherein the casing has an opening,
a display unit is provided in the opening, and
the film antenna is provided on the display unit and in a region of the opening.

16. The mobile communication terminal according to claim 2,
wherein the film antenna is an array antenna.

17. The mobile communication terminal according to claim 2,
wherein the film antenna is a phased array antenna.

18. The mobile communication terminal according to claim 2,
wherein the proximity sensor is an infrared sensor using infrared rays.

19. The mobile communication terminal according to claim 2,
wherein the proximity sensor includes the casing antenna.

20. The mobile communication terminal according to claim 2,
wherein the casing antenna has a maximum length of 2 cm or less.
